(19) United States
(12) Patent Application Publication
(10) Pub. No.: US 2025/0026981 A1
(43) Pub. Date: Jan. 23, 2025

(54) HYDROCHROMIC HALIDE PEROVSKITE, ITS PREPARATION AND USE THE SAME

(71) Applicant: City University of Hong Kong, Kowloon (HK)

(72) Inventors: Feng Wang, Kowloon (HK); Jiangkun Chen, Kowloon (HK)

(21) Appl. No.: 18/356,646

(22) Filed: Jul. 21, 2023

(51) Int. Cl. C09K 11/66; C09K 11/06

(52) U.S. Cl. CPC C09K 11/665; C09K 11/06; C09K 2211/10

(57) ABSTRACT

A hydrochromic halide perovskite includes a CsₓTb_{y}F_{z} halide perovskite doped with a lanthanide ion dopant, which is capable of water-induced reversible phase transformation between pristine state and wet state, and exhibits reversible change in optical emission under ultraviolet excitation. A printable pattern comprising a film of the hydrochromic halide perovskite and a method for preparing the hydrochromic halide perovskite are also addressed.

### TECHNICAL FIELD

The present invention relates to a hydrochromic halide perovskite for example particularly, but not exclusively, a hydrochromic halide perovskite comprising a CsₓTb_{y}F_{z} halide perovskite doped with a lanthanide ion dopant; and a method for preparing the same. Also pertaining to the present invention is a printable pattern comprising a film of the hydrochromic halide perovskite.

### BACKGROUND OF THE INVENTION

Water is one of the most common stimuli in the natural environment, featuring ecological friendliness, economy, and simplicity. Consequently, hydrochromic materials have intrigued special attention compared with other stimulus-responsive systems, such as mechanochromics, photochromics, thermochromics, and solvatochromics.

Typical examples of hydrochromic materials may include π-conjugated polydiacetylenes (PDAs), inorganic crystals such as some specialized carbon dots (CDs), and metal halide perovskites such as CsPbX₃ (X=Cl, Br, and I). However, it is noted that each of these typical materials may suffer from one or more of the following shortcomings such as: slow response rate to water (such as by dozens of seconds), limited transformation reversibility, stringently controlled structure for achieving hydrochromic luminescence, limited optical tunability, instability under ambient conditions, use of toxic lead ions, inherent colors with unadjustable optical features, etc. Thus, it is believed that the development of a hydrochromic material with improved optical tunability and hydrochromic performance remains a challenge.

The invention seeks to eliminate or at least to mitigate such shortcomings by providing a new or otherwise improved hydrochromic material, in particular, a hydrochromic halide perovskite (such as the one with B site comprising Tb³⁺ ion) doped with a lanthanide ion dopant, which is capable of water-induced reversible phase transformation between pristine state and wet state, and exhibits reversible change in optical emission under ultraviolet excitation.

### SUMMARY OF THE INVENTION

In a first aspect of the present invention, there is provided a hydrochromic halide perovskite comprising a CsₓTb_{y}F_{z} halide perovskite doped with a lanthanide ion dopant, which is capable of water-induced reversible phase transformation between pristine state and wet state, and exhibits reversible change in optical emission under ultraviolet excitation. In an optional embodiment, the lanthanide ion dopant comprises Eu³⁺, in the pristine state, x is 3, y is 1 and z is 6, and in the wet state, x is 1, y is 2 and z is 7.

Optionally, the optical emission of Cs₃TbF₆ doped with Eu³⁺ can be controlled by changing the wavelength of the ultraviolet during the ultraviolet excitation. It is optional that the wavelength is selected from any one of between about 365 nm to about 395 nm.

Optionally, the optical emission of Cs₃TbF₆ doped with Eu³⁺ under UV excitation at specific wavelength is changeable by adjusting concentration of the Eu³⁺ dopant.

In an embodiment of the invention, the halide perovskite is reversibly transformable between a zero-dimensional structure of Cs₃TbF₆ at the pristine state and a one-dimensional structure of CsTb₂F₇ in the wet state.

It is optional that the optical emission of Cs₃TbF₆ doped with Eu³⁺ under the UV excitation at about 365 nm is changeable from green to orange by adjusting concentration of the Eu³⁺ dopant when the Cs₃TbF₆ doped with Eu³⁺ is in the pristine state.

It is also optional that the optical emission of Cs₃TbF₆ doped with Eu³⁺ under UV excitation at about 393 nm is changeable from non-fluorescent to pink by adjusting concentration of the Eu³⁺ dopant when the Cs₃TbF₆ doped with Eu³⁺ is in the pristine state.

In an optional embodiment, the CsₓTb_{y}F_{z} is co-doped with the lanthanide ion dopant and a rare earth metal ion, optical emission wavelength of a co-doped lanthanide-based halide perovskite is changeable by adjusting relative concentration of the lanthanide ion dopant and rare earth metal ion dopant. Optionally, x is 1 or 3, y is 1 or 2 and z is 6 or 7 and the lanthanide ion dopant comprises Eu³⁺ and the rare earth metal ion comprises Y³⁺, the optical emission under UV excitation is changeable by adjusting concentration of the Eu³⁺ and Y³⁺ dopants. It is optional that the concentration of the Eu³⁺ dopant is adjustable between 1 mol % and 30 mol % and the concentration of the Y³⁺ dopant is adjustable between 0 mol % and 70 mol %.

In an embodiment of the invention, the optical emission of CsTb₂F₇ doped with Eu³⁺ and Y³⁺ ions under UV excitation at about 365 nm is changeable from orange to green by adjusting concentration of the Eu³⁺ and Y³⁺ dopants.

It is optional that the transformation from the zero-dimensional structure to the one-dimensional structure reaches 90% in a response time of about 20 ms.

In an optional embodiment, the response time is changeable by adjusting water absorption ability of the Eu³⁺ doped CsₓTb_{y}F_{z}. Optionally, the water absorption ability of the Eu³⁺ doped CsₓTb_{y}F_{z} is adjustable by partly forming Rb-alloyed Cs₃TbF₆:Eu³⁺.

In a second aspect of the present invention, there is provided a printable pattern comprising a film of hydrochromic halide perovskite in accordance with the first aspect. Optionally, the film comprises at least first and second layers, the first layer comprises CsₓTb_{y}F_{z} doped with Eu³⁺ ion. It is optional that the second layer comprises CsₓTb_{y}F_{z} doped with Eu³⁺ and Y³⁺ ions or Cs₃TbF₆.

In a third aspect of the present invention, there is provided a method for preparing the hydrochromic halide perovskite in accordance with the first aspect, comprising the steps of: providing a mixture comprising a Cs source, a Tb source, a F source, and a lanthanide source; and annealing the mixture at an elevated temperature for a predetermined time.

Optionally, the method further comprises a step of grinding the mixture prior to annealing.

In an optional embodiment, the mixture comprises stoichiometric amount of CsCO₃, TbF₃, NH₄F, and EuF₃. Optionally, molar ratio of Cs:Tb:F:Eu in the mixture is from about 3:0.99:6:0.01 to about 3:0.7:6:0.3.

In an optional embodiment, the mixture further comprises YF₃. It is optional that molar ratio of Cs:Tb:F:Eu:Y in the mixture is from about 3:0.89:6:0.01:10 to about 3:0.29:6:0.01:70.

In an optional embodiment, the mixture further comprises Rb₂CO₃. It is optional that molar ratio of Cs:Rb:Tb:F:Eu in the mixture is from about 2.4:0.6:0.99:6:0.01 to about 0:3:0.99:6:0.01.

Optionally, the annealing is performed at about 150° C. to about 500° C. for about 2 h.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The invention will now be more particularly described, by way of example only, with reference to the accompanying drawings, in which:

FIG. 1A is a schematic diagram illustrating the crystal structure of Cs₃TbF₆ in accordance with an embodiment of the present invention;

FIG. 1B is a schematic diagram illustrating the crystal structure of CsTb₂F₇ in accordance with an embodiment of the present invention;

FIG. 2 is a table summarizing the lattice parameters of Cs₃TbF₆ and CsTb₂F₇ crystal structure obtained by Density Functional Theory (DFT) calculations;

FIG. 3A shows the X-ray diffraction (XRD) patterns of Cs₃TbF₆:Eu³⁺ (1%) prepared by heating the starting materials at different temperatures from 100-600° C. for 2 h. The results show that the target product of Cs₃TbF₆ crystals started to form at 150° C., and the most suitable synthesis temperature was in the range of 150-500° C.;

FIG. 3B shows the XRD pattern of the as-synthesized Cs₃TbF₆:Eu³⁺ (1%) crystals. The black line spectrum is the simulated result for tetragonal Cs₃TbF₆. The inset is the crystal structure diagram of Cs₃TbF₆;

FIG. 4A is a scanning electron microscope (SEM) image of the Cs₃TbF₆:Eu³⁺ (5%) crystals, with a magnification scale of 2 μm;

FIG. 4B shows the elemental maps of Cs, Tb, and Eu of the Cs₃TbF₆:Eu³⁺ (5%) crystals in FIG. 4A;

FIG. 4C shows an energy-dispersive X-ray (EDX) spectrum of the Cs₃TbF₆:Eu³⁺ (5%) crystals in FIG. 4A;

FIG. 5 is a table summarizing inductively coupled plasma-optical emission spectroscopy (ICP-OES) results of Cs₃TbF₆:Eu³⁺ (1%) crystals

FIG. 6A shows the charge density isosurface at the (001) plane in Eu³⁺-doped Cs₃TbF₆ that shows decoupling of electronic orbitals between neighboring [TbF₆]³⁻ and [EuF₆]³⁻ polyhedral;

FIG. 6B shows the excitation spectra of Cs₃TbF₆:Eu³⁺ (1%) crystals recorded by monitoring the emissions at 552 nm (top panel) and 593 nm (bottom panel), respectively. The dashed line indicates the ⁷F₀→⁵L₆ transition of Eu³⁺;

FIG. 7A shows the emission spectra of the Cs₃TbF₆:Eu³⁺ (1%) crystals under 377 nm (top panel) and 393 nm (bottom panel) excitation, respectively;

FIG. 7B shows the decay curves of bare Cs₃TbF₆ and Cs₃TbF₆:Eu³⁺ (1%) crystals;

FIG. 8 shows the photographs of as-synthesized Cs₃TbF₆:Eu³⁺ (1%) before and after water exposure;

FIG. 9 shows the XRD pattern of the Cs₃TbF₆:Eu³⁺ crystals after water exposure. The line spectra are literature data for orthorhombic-phase CsDy₂F₇(PDF #27-0112). The inset is the crystal structure diagram of CsTb₂F₇;

FIG. 10A shows the XRD pattern of Cs₃TbF₆:Eu³⁺ (1%) crystals after methanol treatment. The results showed that the sample was essentially unaffected by methanol;

FIG. 10B shows the excitation/emission spectra of Cs₃TbF₆:Eu³⁺ (1%) crystals after methanol treatment;

FIG. 11 shows the excitation spectra of wet Cs₃TbF₆:Eu³⁺ (1%) crystals by monitoring the emission at 552 nm (top panel) and 593 nm (bottom panel), respectively. The dashed line indicates the ⁷F₀→⁵L₆ transition of Eu³⁺;

FIG. 12A shows the charge density isosurface at the (007) plane in Eu³⁺-doped CsTb₂F₇ that shows coupling of electronic orbitals between the neighboring [TbF₇]⁴⁻ and [EuF₇]⁴⁻ polyhedral;

FIG. 12B is a schematic diagram illustrating the distance between adjacent lanthanide ions in Cs₃TbF₆ and CsTb₂F₇ crystals;

FIG. 13A shows the emission spectra of wet Cs₃TbF₆:Eu³⁺ (1%) crystals under 377 nm (top panel) and 393 nm (bottom panel) excitation, respectively;

FIG. 13B shows the XRD pattern of synthetic CsTb₂F₇:Eu³⁺ (1%) crystal. The line spectra are literature data for orthorhombic phase CsDy₂F₇ (PDF #27-0112);

FIG. 13C shows the excitation and emission spectra of hydrolyzed Cs₃TbF₆:Eu³⁺ (1%) and synthetic CsTb₂F₇:Eu³⁺ (1%) crystals;

FIG. 14 shows the decay curves of bare Cs₃TbF₆ and Cs₃TbF₆:Eu³⁺ (1%) crystals after water treatment;

FIG. 15 shows the emission spectra of Cs₃TbF₆:Eu³⁺ (1%) crystals before and after water treatment under 377 nm excitation;

FIG. 16 shows the calculated electronic band structures and corresponding projected density of states (PDOS) of Cs₃TbF₆:Eu³⁺ (top panel) and CsTb₂F₇:Eu³⁺ (bottom panel), respectively;

FIG. 17 shows the emission spectra of Cs₃TbF₆:Eu³⁺ (1%) crystals as a function of water contact time. The sample was constantly excited using a hand-held UV lamp, and the measurement was started immediately after adding water. The spectra were continuously collected by setting an integration time of 10 ms;

FIG. 18 shows the contour plot of the emission spectrum of Cs₃TbF₆:Eu³⁺ (1%) crystals as a function of water contact time;

FIG. 19 shows the integral intensity ratios of green and red emissions as a function of water contact time in Cs₃TbF₆:Eu³⁺ (1%) crystals. The error bar represents the standard deviation of three repeated measurements. The insets are the corresponding photographs;

FIG. 20 is a table summarizing the comparison of hydrochromic response time between different materials;

FIG. 21 shows the XRD patterns of Cs₃₋ₓRbₓTbF₆:Eu³⁺ (1%) crystals. The spectral shift toward higher diffraction angles can be attributed to the substitution of apparently smaller Rb⁺ for Cs⁺ centers in the crystal lattice, resulting in a smaller unit-cell volume;

FIG. 22 shows the emission spectra of Cs₃₋ₓRbₓTbF₆:Eu³⁺ (1%) crystals before and after water exposure;

FIG. 23A shows the contour plot of the emission spectra of Cs₃₋ₓRbₓTbF₆:Eu³⁺ (1%) crystals as a function of water exposure time;

FIG. 23B shows the plot of the intensity ratios of green-to-red emissions of Cs₃₋ₓRbₓTbF₆:Eu³⁺ (1%) crystals as a function of water exposure time;

FIG. 23C shows the plot of hydrochromic response time as a function of Rb⁺ doping concentration in Cs₃TbF₆:Eu³⁺ (1%) crystals. The inset shows the solubility of RbF and CsF in water at 18° C.;

FIG. 24 shows the weight evolution curves of the Cs₃TbF₆:Eu³⁺ (1%) and RbTbF₆:Eu³⁺ (1%) crystals as a function of exposure time in air. The dashed lines 2402 and 2404 indicate the times required for Cs₃TbF₆ and Rb₃TbF₆ crystals to reach weight saturation, respectively;

FIG. 25 shows the XRD pattern of Rb₃TbF₆ crystals after water treatment. The marked impurity diffraction peaks belong to RbF;

FIG. 26A shows the SEM images of Cs₃TbF₆:Eu³⁺ (0-30%) crystals;

FIG. 26B shows the XRD patterns of Cs₃TbF₆:Eu³⁺ (0-30%) crystals of FIG. 26A. The spectral shift toward lower diffraction angles can be attributed to the substitution of apparently larger Eu³⁺ for Tb³⁺ centers in the crystal lattice, resulting in a larger unit-cell volume;

FIG. 27A shows the SEM images of Cs₃TbF₆:Eu³⁺/Y³⁺ (1%/0-70%) crystals;

FIG. 27B shows the XRD patterns of Cs₃TbF₆:Eu³⁺/Y³⁺ (1%/0-70%) crystals of FIG. 27A;

FIG. 28A shows the SEM images of Cs₃TbF₆:Y³⁺ (10-70%) crystals;

FIG. 28B shows the XRD patterns of Cs₃TbF₆:Y³⁺ (10-70%) crystals of FIG. 28A;

FIG. 29 is a schematic diagram illustrating the doping-controlling energy transfer from Tb³⁺ to Eu³⁺;

FIG. 30A shows the emission spectra of as-synthesized Cs₃TbF₆:Eu³⁺ (0-30%) crystals before and after water contact under 377 nm excitation;

FIG. 30B shows the energy transfer efficiency as a function of Eu³⁺/Y³⁺ doping concentration in the pristine and wet samples under 377 nm excitation, respectively. The dotted line indicates the energy transfer efficiency of 50%;

FIG. 30C shows the decay curves of Cs₃TbF₆:Eu³⁺ (0-30%) crystals before and after water treatment corresponding to FIG. 30A;

FIG. 31A shows the emission spectra of Cs₃TbF₆:Eu³⁺/Y³⁺ (1%/0-70%) crystals before and after water contact under 377 nm excitation;

FIG. 31B shows the decay curves of Cs₃TbF₆:Eu³⁺/Y³⁺ (1%/0-70%) crystals before and after water treatment corresponding to FIG. 31A;

FIG. 31C shows the decay curves of Cs₃TbF₆:Y³⁺ (10-70%) crystals before and after water treatment;

FIG. 32 shows the corresponding luminescence photographs of the samples in FIG. 30B under 365 nm excitation;

FIG. 33 shows the integral emission intensity of the Cs₃TbF₆:Eu³⁺ (1%) crystals under continuous irradiation of a 365 nm UV lamp at 373 K. The inset is a comparison of the initial and final emission profiles;

FIG. 34A shows the XRD pattern of the Cs₃TbF₆:Eu³⁺ (1%) crystals after photothermal stability test;

FIG. 34B shows the thermogravimetric (TG) curves of the Cs₃TbF₆:Eu³⁺ (1%) crystals, showing that the sample weight remained stable at temperature up to −600° C.;

FIG. 35A shows the red-to-green intensity ratios of the Cs₃TbF₆:Eu³⁺ (1%) crystals in 20 wetting-drying cycles;

FIG. 35B shows the XRD patterns of Cs₃TbF₆:Eu³⁺ (1%) crystals in pristine and after 20 wetting-drying cycles. Only a negligible amount of CsTb₂F₇ residues (indicated by asterisks) were detected after the cycling test, which showed no noticeable effect on the overall luminescence properties;

FIG. 36 shows the formation energy of Cs₃TbF₆ and CsTb₂F₇ crystals obtained by DFT calculation;

FIG. 37A is a schematic diagram illustrating the multicolor pattern preparation through serial screen printing;

FIG. 37B shows the photograph of the pattern under ambient light;

FIG. 37C shows the luminescence photographs of an orange pattern under 365 nm UV lamp excitation in a wetting-drying cycle;

FIG. 38A shows the coordinate plane which illustrates the design principle of two-dimensional encryption based on excitation wavelength and stimulus conditions;

FIG. 38B is a schematic diagram illustrating the QR pattern preparation through serial screen printing; and

FIG. 38C shows the output codes of the QR pattern under different excitation and stimulus parameters.

### DETAILED DESCRIPTION OF OPTIONAL EMBODIMENT

As used herein, the forms “a”, “an”, and “the” are intended to include the singular and plural forms unless the context clearly indicates otherwise.

The words “example” or “exemplary” used in this invention are intended to serve as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

Without intending to be limited by theory, the inventors have, through their own research, trials, and experiments, devised a hydrochromic material comprising a halide perovskite, particularly a halide perovskite with a lanthanide ion dopant, that can provide fine-tuning of optical properties such as hydrochromism response time, hydrochromic emission colors, etc. by controlling the dopant composition and/or concentration. The hydrochromic material is devised by employing a CsₓTb_{y}F_{z} halide perovskite doped with a lanthanide ion dopant, which is capable of water-induced reversible phase transformation between pristine state and wet state, leading to a reversible change in optical emission under ultraviolet excitation.

According to the present invention, there is provided a hydrochromic halide perovskite comprising a CsₓTb_{y}F_{z} halide perovskite doped with a lanthanide ion dopant, which is capable of water-induced reversible phase transformation between pristine state and wet state, and exhibits reversible change in optical emission under ultraviolet excitation.

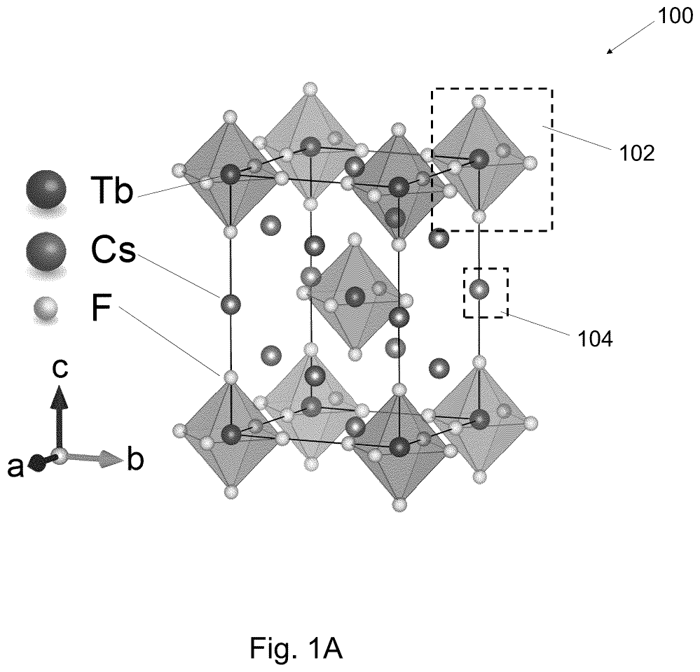

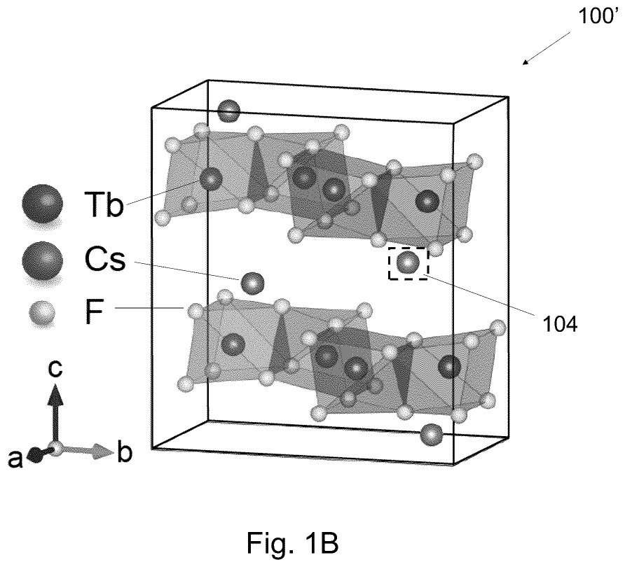

The lanthanide-doped CsₓTb_{y}F_{z} halide perovskite may have a pure phase with high crystallinity. In an example embodiment, where the lanthanide ion dopant comprises Eu³⁺, x is 3, y is 1 and z is 6, i.e., the CsₓTb_{y}F_{z} halide perovskite is in its pristine state, it may have a lattice structure 100 as exemplified in FIG. 1A. As shown, the pristine lanthanide-doped Cs₃TbF₆ (i.e., Cs₃TbF₆:Eu³⁺) has a body-centered tetragonal (BCT) lattice structure, with a space group of I4/mmm. In this rutile-type perovskite structure, [TbF₆]³⁻ octahedral 102 and vacancies are alternately arranged and separated by Cs⁺ ions 104, suggesting a zero-dimensional (0D) perovskite structure of Cs₃TbF₆:Eu³⁺.

In particular, the optical emission of Cs₃TbF₆:Eu³⁺ (Cs₃TbF₆ doped with Eu³⁺) may be controlled by changing the wavelength of the ultraviolet during ultraviolet excitation, particularly with an excitation wavelength selected from any one of between about 365 nm to about 395 nm. For example, upon an UV excitation of about 365 nm to about 377 nm, the Cs₃TbF₆:Eu³⁺ may emit a green emission whereas when the UV excitation is changed to about 393 nm to about 395 nm, the Cs₃TbF₆:Eu³⁺ may emit a red (or pink) emission instead.

In addition to be controlled by changing the wavelength of the ultraviolet during the ultraviolet excitation, it is found that, optionally, the optical emission of pristine Cs₃TbF₆ doped with Eu³⁺ under UV excitation at specific wavelength may be changeable by adjusting concentration of the Eu³⁺ dopant. For example, in an embodiment where Cs₃TbF₆ is doped with 1% Eu³⁺ (Cs₃TbF₆:Eu³⁺ (1%)), upon photoexcitation at about 365 nm to about 377 nm, it may emit a green emission. On the other hand, when the concentration of the Eu³⁺ dopant increases, such as from about 1% to about 30%, the emission color of Cs₃TbF₆:Eu³⁺ may be changed from green to orange under the same photoexcitation wavelength(s).

Optionally or additionally, when the pristine Cs₃TbF₆ doped with Eu³⁺ is excited at about 393 nm, the optical emission thereof may be changeable by adjusting concentration of the Eu³⁺ dopant as well. In an example embodiment, the optical emission of the pristine Cs₃TbF₆ doped with Eu³⁺ under an excitation of about 393 nm may be changeable from non-fluorescent to pink upon increasing the Eu³⁺ concentration from 0 mol % to 30 mol %.

As mentioned, the lanthanide-doped CsₓTb_{y}F_{z} halide perovskite of the present invention is capable of water-induced reversible phase transformation between pristine state and wet state. For example, in an embodiment where the lanthanide-doped CsₓTb_{y}F_{z} halide perovskite is Cs₃TbF₆:Eu³⁺, it may undergo a reversible phase transformation between a zero-dimensional (0D) (pervoskite) structure of Cs₃TbF₆ at the pristine state and a one-dimensional (1D) (non-perovskite) structure of CsTb₂F₇:Eu³⁺ in the wet state, which may have an orthorhomic lattice structure 100′ as shown in FIG. 1B. In particular, it is believed that such transformation is ascribed to a Cs—F stripping process as a result of the high solubility of CsF in water. When water molecules are removed from the bulk system, the (initial) 0D structure of Cs₃TbF₆:Eu³⁺ may be recovered from the 1D structure of CsTb₂F₇:Eu³⁺. In an example embodiment, the Cs₃TbF₆:Eu³⁺ may remain intact after subjecting to at least 20 wetting-drying cycles.

Preferably, such a reversible phase transformation may accompany with a change of optical emission properties of the halide perovskite in wet state as compared with that in the pristine state upon photoexcitation, particularly the optical emission (color or wavelength) of the wet halide perovskite may become independent from the excitation wavelength as compared with the pristine halide perovskite. For example, referring again to FIG. 1B which shows the orthorhombic lattice structure of 1D structure of CsTb₂F₇:Eu³⁺ (i.e., Cs₃TbF₆:Eu³⁺ in wet state), upon phase transformation, it may activate the coupling of neighboring polyhedral units due to the contraction of the lanthanide sublattice. As such, it may lead to luminescence processes that are essentially independent from the excitation wavelength, which is in contrast to the pristine Cs₃TbF₆:Eu³⁺. In a particular example embodiment, the emission spectra of CsTb₂F₇:Eu³⁺ may be dominated by Eu³⁺ peaks under both about 377 nm and about 393 nm excitation.

Given that the change of luminescence of pristine Cs₃TbF₆:Eu³⁺ from excitation wavelength-dependent to excitation wavelength-independent when it is transformed into wet state (i.e., CsTb₂F₇:Eu³⁺), it is appreciated that the luminescence switching in the lanthanide-doped CsₓTb_{y}F_{z}, particularly Cs₃TbF₆ may be controlled by interaction of individual polyhedrons, and therefore the hydrochromic behavior may be tuned by modulating the interpolyhedral energy transfer through supplementary doping such as co-doping one or more of an additional lanthanide ion or rare earth metal ion.

In an embodiment, the CsₓTb_{y}F_{z} (such as with x being 1 or 3, y being 1 or 2 and z being 6 or 7) may be co-doped with a lanthanide ion dopant such as Eu³⁺ and a rare earth metal ion such as Y³⁺. The optical emission wavelength of such co-doped lanthanide-based halide perovskite, particularly under UV excitation, may be changeable by adjusting relative concentration of the lanthanide ion dopant and rare earth metal ion dopant. In particular, it is believed that upon incorporating the Y³⁺ ion into the host lattice (i.e., CsₓTb_{y}F_{z}), the phase transformation of the CsₓTb_{y}F_{z} as described herein would no longer bring the Tb³⁺ and Eu³⁺ into close proximity, thus the energy transfer therebetween would be suppressed, affecting the hydrochromic switching process.

As a specific embodiment, the halide perovskite CsₓTb_{y}F_{z} may be Cs₃TbF₆ co-doped with Eu³⁺ and Y³⁺ in the pristine state (i.e., Cs₃TbF₆:Eu³⁺/Y³⁺) and CsTb₂F₇:Eu³⁺/Y³⁺ in the wet state. The doping concentration of the Eu³⁺ dopant may be adjustable between 1 mol % and 30 mol % whereas the concentration of the Y³⁺ dopant may be adjustable between 0 mol % and 70 mol %.

In an example embodiment, the pristine Cs₃TbF₆ may be doped with 1% Eu³⁺ and with a gradual increasing concentration of Y³⁺, such as 10 mol %, 20 mol %, 30 mol %, 40 mol %, 50 mol %, 60 mol %, 70 mol % and the like. Upon absorption of water, the pristine Cs₃TbF₆:Eu³⁺/Y³⁺ (1%/10-70%) may undergo a reversible phase transformation as described herein to form the wet Cs₃TbF₆:Eu³⁺/Y³⁺ (1%/10-70%) (i.e., CsTb₂F₇:Eu³⁺/Y³⁺ (1%/10-70%)). Under UV excitation at about 365 nm to about 377 nm, CsTb₂F₇:Eu³⁺/Y³⁺ (1%/10-70%) may have a change of optical emission from orange to green with the increase of co-doped Y³⁺ concentrations.

As described herein, the conversion of the pristine CsₓTb_{y}F_{z} such as Cs₃TbF₆:Eu³⁺ to the wet CsₓTb_{y}F_{z} such as CsTb₂F₇:Eu³⁺ involves a reversible phase transformation of the zero-dimensional structure to the one-dimensional structure, which is believed to be a result of a CsF stripping process. In an embodiment, it is found that such reversible phase transformation may reach 90% in a response time of about 20 ms. Advantageously, it is believed that such a rapid hydrochromic response has never been observed in any other reported inorganic counterparts. Details will be discussed in the later part of the present disclosure.

In particular, it is devised that the response time may be changeable by adjusting water absorption ability of the Eu³⁺ doped CsₓTb_{y}F_{z}, such as by way of partly forming Rb-alloyed Cs₃TbF₆:Eu³⁺. The phrase “alloyed” is intended to distinguish from the phrase “doped” as used herein even though both of which are directed to an intended addition of external metal ion into the (host/base) crystal lattice structure. In particular, it is appreciated that the phrase “alloyed” may involve a high-degree substitution (such as up to 100%) of lattice sites such as A-site and/or B-site cation(s) by isovalent dopant, and may be intended to modify the chemical and/or structural features of the host/base crystals. In contrast, it is appreciated that while the phrase “doped” also involves replacement of host cations by guest cations, the dopant ion may be incorporated into lattice sties and/or interstitial sites, and it may be primarily intended to modify the electronic properties of the host/base material.

For example, in the embodiments, the hydrochromic halide perovskite Cs₃TbF₆:Eu³⁺ (1%) may be alloyed with about 20 mol % to about 100 mol % of Rb ion, forming a series of Rb-alloyed Cs₃TbF₆:Eu³⁺. That said, upon alloying with Rb ion, the A-site cation, i.e. Cs⁺ ion may be partially substituted with the Rb ion, forming a series of Cs₃₋ₓRbₓTbF₆:Eu³⁺ (1%), with x being 0.6, 1.2, 1.8, 2.4, or 3. In particular, the Rb-alloyed Cs₃TbF₆:Eu³⁺ in the embodiments may have a hydrochromic response time extended from about millisecond scale to about second scale upon increasing the alloyed Rb concentrations, which may be attributed to the production of less water-soluble (as compared with CsF) RbF, leading to a substantially reduced water absorption.

Based on the above, it is believed that the tunable/adjustable optical emission of the hydrochromic halide perovskite of the present invention may be applicable to information encryption. Thus, according to another aspect of the invention, there is provided a printable pattern comprising a film of hydrochromic halide perovskite as described herein. In particular, the film may comprise at least first and second layers and each of which may be printed with a portion of a desired pattern, which, when overlaid, a completed (desired) pattern would be observed when viewed on top of the film. Preferably, each layer may comprise a halide perovskite CsₓTb_{y}F_{z} with different lanthanide ion dopant and/or rare earth metal ion dopant concentrations, such that the desired pattern may be extracted/observed/recognized by using a particular combination of excitation wavelength and/or stimulus conditions.

For example, in an embodiment, the first layer may comprise CsₓTb_{y}F_{z} doped with Eu³⁺ ion such as Cs₃TbF₆:Eu³⁺ (1%-5%), whereas the second layer may comprise CsₓTb_{y}F_{z} doped with Eu³⁺ and Y³⁺ ions such as Cs₃TbF₆:Eu³⁺/Y³⁺ (1%/40%-70%) or Cs₃TbF₆. The desired pattern may only be observed when a specific combination of excitation wavelength and/or stimulus conditions. In an example embodiment, the desired pattern may only be recognizable under simultaneous UV excitation and water stimulus, but being concealed upon evaporation of water. Detailed examples of employing the hydrochromic halide perovskite as described herein for information encryption will be discussed in the later part of the present disclosure.

Optionally or additionally, the film of hydrochromic halide perovskite as described herein may be prepared by any suitable techniques in the art. For example, the film may be prepared spin-coating, spray-coating, brushing, 3D printing and the like the pattern with the hydrochromic halide perovskite as described herein onto a transparent film substrate.

Further pertaining to the present invention is a method for preparing the hydrochromic halide perovskite as described herein. In the embodiments of the present invention, the method may involve a solid-state reaction. In particular, the method may comprise the steps of: providing a mixture comprising a Cs source, a Tb source, a F source, and a lanthanide source; and annealing the mixture at an elevated temperature for a predetermined time.

In an embodiment, the mixture may comprise a stoichiometric amount of CsCO₃, TbF₃, NH₄F, and EuF₃. For example, the molar ratio of Cs:Tb:F:Eu in the mixture is from about 3:0.99:6:0.01 to about 3:0.7:6:0.3. In an optional embodiment, the mixture may further comprise a rare earth metal ion source such as YF₃. In this embodiment, the molar ratio of Cs:Tb:F:Eu:Y in the mixture may be from about 3:0.89:6:0.01:0.1 to about 3:0.29:6:0.01:0.7. In another optional embodiment, the mixture may further comprise an alkali metal ion source such as Rb₂CO₃. In this embodiment, the molar ratio of Cs:Rb:Tb:Eu in the mixture may be from about 2.4:0.6:0.99:6:0.01 to about 0:3:0.99:6:0.01.

Preferably, the mixture in the above embodiments may be subjected to a step of grinding prior to the annealing step, such that the raw materials (i.e., CsCO₃, TbF₃, NH₄F, EuF₃, YF₃, and/or Rb₂CO₃) may be uniformly mixed. In particular, the grinding may be performed by way of grinding the raw materials in an agate mortar, ball milling and the like.

After grinding, the mixture may be transferred into a container such as an alumina crucible for annealing. In particular, the annealing step may be performed at a temperature range from about 150° C. to about 500° C. for, e.g., 2 h in a muffle furnace. At this stage, the hydrochromic halide perovskite as described herein would be obtained upon cooling to, for example, room temperature.

Optionally or additionally, it is appreciated that a skilled person may further perform any purification step such as by way of washing the as-prepared hydrochromic halide perovskite with a suitable solvent, and/or may further perform a grinding step to grind the as-prepared hydrochromic halide perovskite into powders according to the practical needs.

Hereinafter, the present invention is described more specifically by way of examples, but the present invention is not limited thereto.

### EXAMPLES

### Reagents

Cesium carbonate (Cs₂CO₃, 99.9%), rubidium carbonate (Rb₂CO₃, 99.9%), terbium(III) fluoride (TbF₃, 99.9%), europium(III) fluoride (EuF₃, 99.9%), and yttrium(III) fluoride (YF₃, 99.9%) were purchased from Shanghai Macklin Biochemical Co., Ltd. Ammonium fluoride (NH₄F) was purchased from Sigma-Aldrich. All reagents were used as received without further purification.

### Methods and Characterization

### Stimulation of Standard XRD Pattern

The optimized lattice parameters were obtained by using geometric optimization in the Vienna Ab initio Simulation Package (VASP) code and plotted by VESTA.

### Simulation of Electronic and Optical Properties

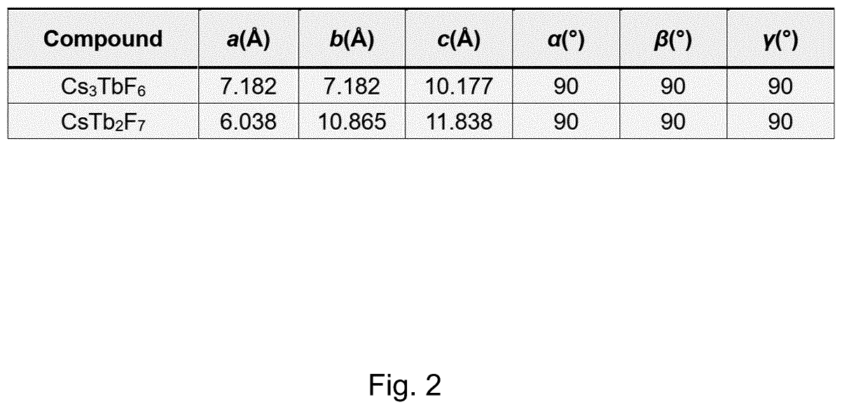

First-principles calculations involving band structure, electron density of states (DOS), and isosurface charge densities were carried out within the plane-wave DFT combined with the projector-augmented wave method, as implemented in the VASP code. We employed the Perdew-Burke-Ernzerhof function with U values of 3.26 eV for Tb³⁺ and 6 eV for Eu³⁺ of the DFT+U method in the geometry optimization and electronic structure calculations. The 5s²5p⁶6s¹ of Cs, 2s²2p⁵ of F, 5s²6s²5p⁶5d⁰4f⁹ of Tb, and 5s²6s²5p⁶5d⁰4f⁷ of Eu were treated as valence electrons. The cutoff energy of the plane wave was set as 500 eV throughout the simulation, and the 2×2×2 k-point mesh in the Brillouin zone was employed. The structure was optimized until the force between each atom was smaller than 0.01 eV/A. The simulated band structure and DOS of Eu³-doped Cs₃TbF₆ and CsTb₂F₇ crystals were analyzed using the VASPKIT code. The VESTA package was used to plot crystal structures and charge density isosurfaces. The lattice parameters of the Cs₃TbF₆ and CsTb₂F₇ crystal structures obtained by DFT calculation are shown in FIG. 2.

### Formation Energy Calculation

The formation energy (Ef) was calculated by first-principles calculations implemented in the VASP code. The exchange-correlation function was treated by generalized-gradient-approximation (GGA) with the Perdew-Burke-Ernzerhof (PBE) function. For the Cs₃TbF₆ and CsTb₂F₇ phases, the formation energies were seen by the functions of E_{f}_{₁}=E_{Cs}_{₃}_{TbF}_{₆}−3E_{CsF}−E_{TbF} and E_{f}_{₂}=E_{CsTb}_{₂}_{F}_{₇}−E_{CsF}−2E_{TbF}_{₃}, respectively.

### Physical Measurement

RD patterns were recorded on a Bruker D2 phaser X-ray diffractometer using Cu K_{α} radiation with λ=1.5406 Å. SEM and EDAX measurements were carried out on a Quattro S environmental scanning electron microscope (Thermo Fisher). The photoluminescence spectra were acquired from an F-4600 spectrophotometer (Hitachi) equipped with an R928 photo-multiplier (PMT). Decay curves were recorded on an FLS980 fluorescence spectrophotometer (Edinburgh Instruments). ICP-OES was conducted on a PE optima 6000. Thermogravimetric (TG) curves were recorded on a dynamic mechanical analyzer (TA Instruments Q800). The time-dependent photoluminescence spectra were recorded on a Maya 2000 Pro high-resolution spectrometer (Ocean Insight).

### Reversibility Test

The as-synthesized powder crystals (about 70 mg) were transferred to a Petri dish in a constant temperature and humidity box (25° C., 70% RH). The sample was allowed to take natural moisture absorption for 22 h, followed by drying at 80° C. for 2 h as a cycle. The weight and emission spectrum were recorded by an electronic balance and a Maya 2000 Pro high-resolution spectrometer (Ocean Insight), respectively.

### Example 1A

### Synthesis of Cs₃TbF₆ Crystals

3 mmol of Cs₂CO₃, 2 mmol of TbF₃, and 6 mmol of NH₄F were mixed in an agate mortar with 2 mL of acetone. After grinding, the mixture was transferred into alumina crucibles and heated to 300° C. for 2 h in a muffle furnace. The final product was obtained by cooling down to room temperature.

### Example 1B

### Synthesis of Cs₃TbF₆:Eu³⁺ (1%) Crystals

3 mmol of Cs₂CO₃, 1.98 mmol of TbF₃, 0.02 mmol of EuF₃, and 6 mmol of NH₄F were mixed in an agate mortar with 2 mL of acetone. After grinding, the mixture was transferred into alumina crucibles and heated to 300° C. for 2 h in a muffle furnace. The final product was obtained by cooling down naturally. All dopant-engineered samples (i.e., Cs₃TbF₆:Eu³⁺ (5, 10, 15, 20, 25, or 30 mol %)) were prepared through a similar process according to the stoichiometric ratio of raw materials.

### Example 1C

### Synthesis of CsTb₂F₇:Eu³⁺ (1%) Crystals

1 mmol of Cs₂CO₃, 3.96 mmol of TbF₃, 0.04 mmol of EuF₃, and 2 mmol of NH₄F were weighed and mixed in an agate mortar with 1 mL of absolute ethanol. After grinding, the mixtures were transferred into alumina crucibles and heated to 450° C. for 2 h in a muffle furnace. The final product was obtained by cooling down naturally.

### Example 1D

### Synthesis of Cs₃TbF₆:Eu³⁺/Y³⁺ (1%/10%) Crystals

3 mmol of Cs₂CO₃, 1.78 mmol of TbF₃, 0.02 mmol of EuF₃, 0.2 mmol YF₃, and 6 mmol of NH₄F were mixed in an agate mortar with 2 mL of acetone. After grinding, the mixture was transferred into alumina crucibles and heated to 300° C. for 2 h in a muffle furnace. The final product was obtained by cooling down to room temperature. All dopant-engineered samples (i.e., Cs₃TbF₆:Eu³⁺/Y³⁺, with % Y³⁺ being 20, 30, 40, 50, 60 or 70%) were prepared through a similar process according to the stoichiometric ratio of raw materials.

### Example 1E

### Synthesis of Cs₃₋ₓRbₓTbF₆:Eu³⁺ (1%) Crystals, with x being 0.6, 1.2, 1.8, 2.4, or 3

2.4 mmol of Cs₂CO₃, 0.6 mmol of Rb₂CO₃, 1.98 mmol of TbF₃, 0.02 mmol of EuF₃, and 6 mmol of NH₄F were mixed in an agate mortar with 2 mL of acetone. After grinding, the mixture was transferred into alumina crucibles and heated to 300° C. for 2 h in a muffle furnace. The final product was obtained by cooling down to room temperature. All dopant-engineered samples (i.e., Cs₃₋ₓRbₓTbF₆:Eu³⁺ (1%), with x being 0.6, 1.2, 1.8, 2.4, or 3) were prepared through a similar process according to the stoichiometric ratio of raw materials.

### Example 2

### Design Structural Characterization

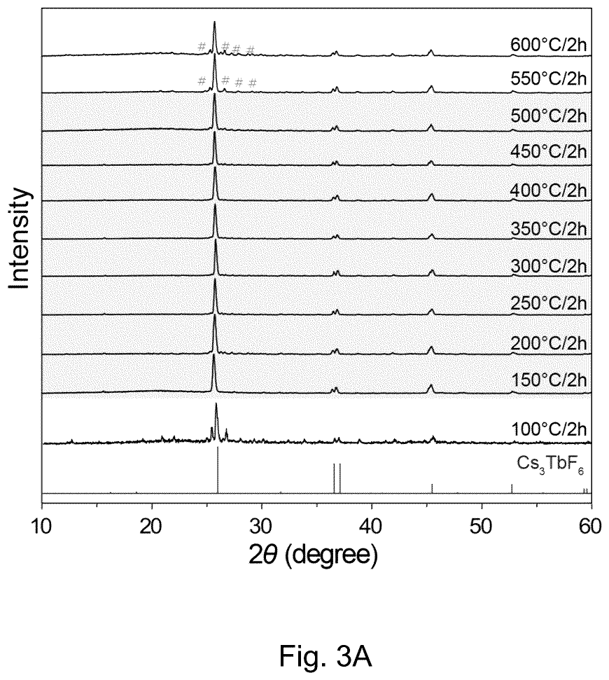

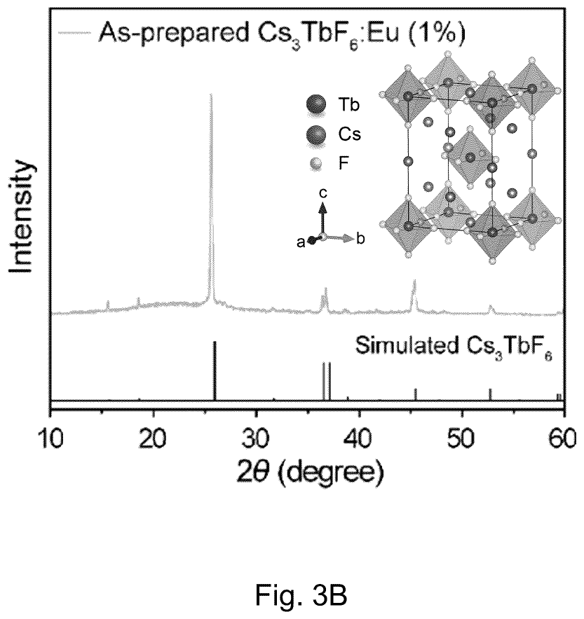

The luminescence of lanthanide compounds generally stems from intra-configurational electronic transitions within individual lanthanide ions. To permit luminescence switching, a Cs₃TbF₆:Eu³⁺ crystal was designed, which is capable of exhibiting dual emissions due to the host Tb³⁺ and dopant Eu³⁺ ions, respectively. In the example embodiments, Cs₃TbF₆ crystals doped with 1% Eu³⁺ were synthesized through a solid-state reaction method. Control experiments revealed an optimal reaction temperature range of 150-500° C. for preparing pure-phase Cs₃TbF₆ crystals with high crystallinity (FIG. 3A).

The powder X-ray diffraction (XRD) pattern of the as-synthesized crystals is illustrated in FIG. 3B, showing diffraction peaks that can be well indexed in accordance with body-centered tetragonal (BCT) Cs₃TbF₆ with a space group of I4/mmm. In this rutile-type perovskite structure, [TbF₆]³⁻ octahedra and vacancies are alternately arranged and separated by Cs⁺ ions, characterized by a zero-dimensional (0D) perovskite structure (FIG. 3B, inset).

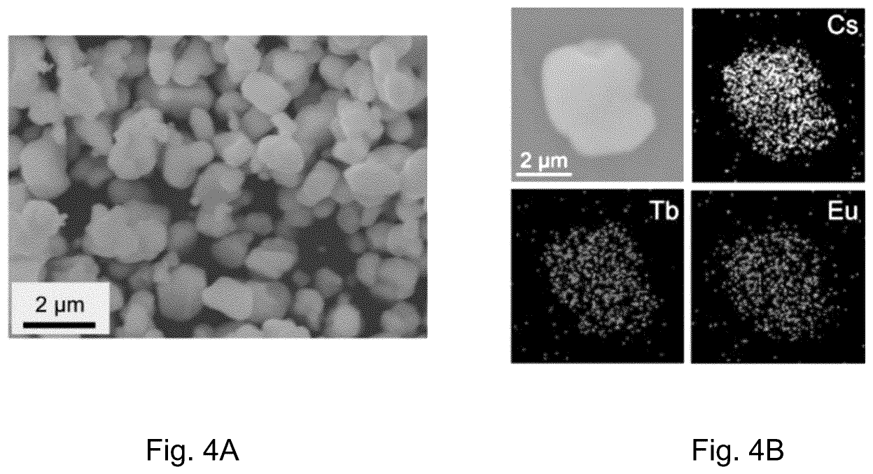

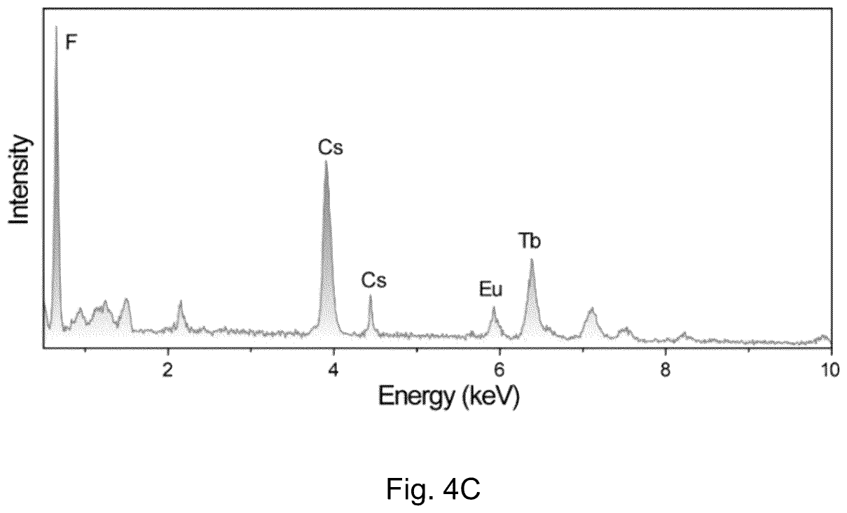

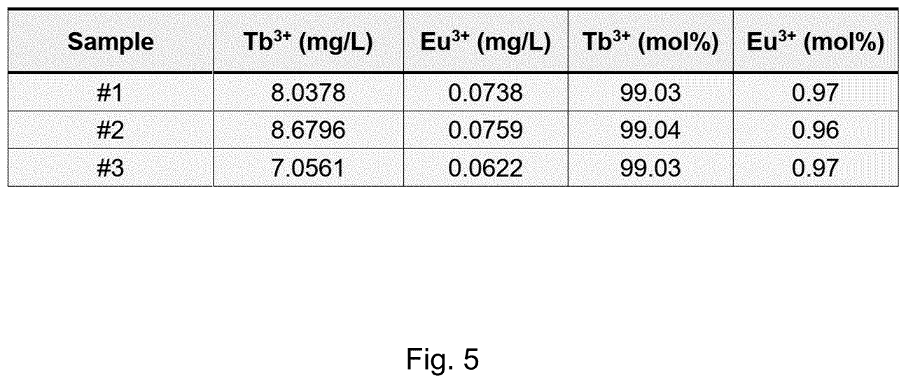

The as-synthesized Cs₃TbF₆:Eu³⁺ crystals had an irregular morphology with a particle size in the 0.5-3 μm range according to scanning electron microscopy (SEM) (FIG. 4A). Compositional analysis by energy-dispersive X-ray spectroscopy (EDX) and elemental mapping reveals the presence of the dopant ions Eu³⁺ with a uniform distribution in the host lattice (FIGS. 4B and 4C). Inductively coupled plasma-optical emission spectroscopy (ICP-OES) further revealed that almost all the dopant ions in the starting materials were successfully doped in the host lattice (FIG. 5).

### Example 3

### Photophysical Characterization

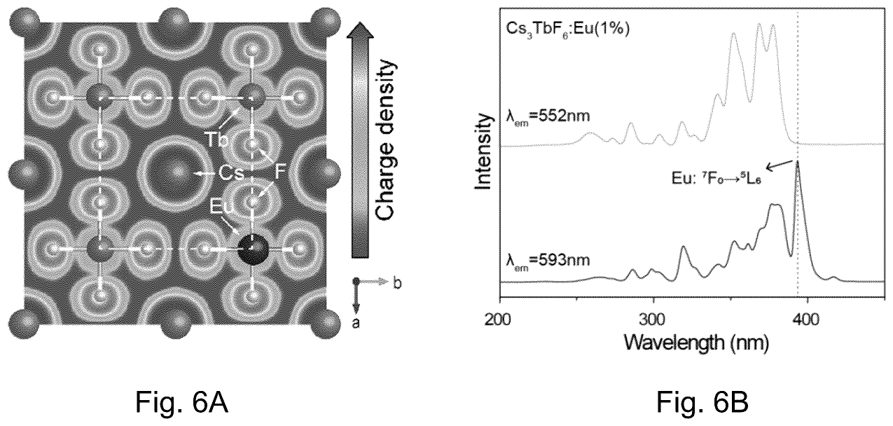

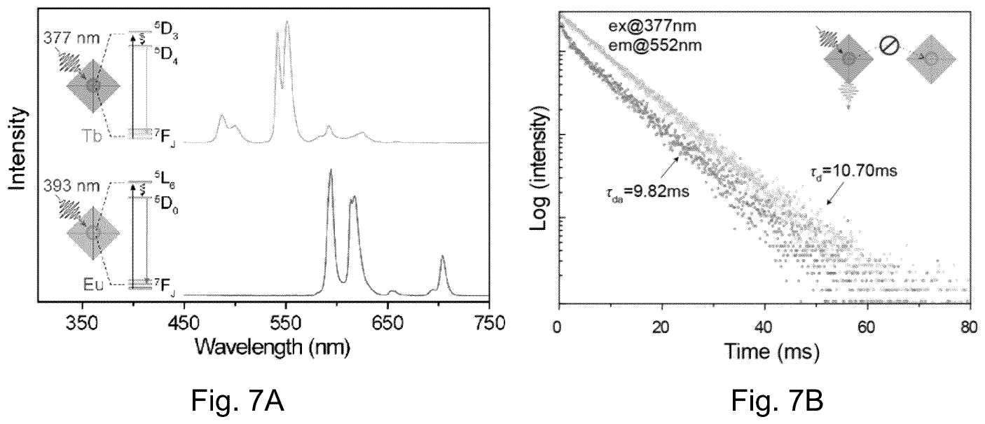

On account of the 0D lattice structure, the neighboring octahedral units showed negligible electronic coupling according to the calculated charge density isosurface (FIG. 6A). Consequently, essentially independent luminescence from the [TbF₆]³⁻ and [EuF₆]³⁻ octahedra was obtained due to their nonoverlapping excitation bands (FIG. 6B). As shown in FIG. 7A, the sample exhibited characteristic green emissions of Tb³⁺ at ˜488/496 nm (⁵D₄→⁷F₆) and ˜542/552 nm (⁵D₄→⁷F₅) upon 377 nm excitation, owing to the selective population of the 5D3 excitation state of Tb3+. By contrast, red emissions of Eu³⁺ at ˜593 nm (⁵D₀→⁷F₁), ˜619 nm (⁵D₀→⁷F₂), and ˜706 nm (⁵D₀→⁷F₄) were exclusively detected under 393 nm excitation, which only populated the ⁵L₆ excitation state of Eu³⁺. Time decay studies detected a marginal change in Tb³⁺ lifetime after Eu³⁺ doping, which confirmed the minimal energy exchange interaction of Tb³⁺ and Eu³⁺ ions (FIG. 7B).

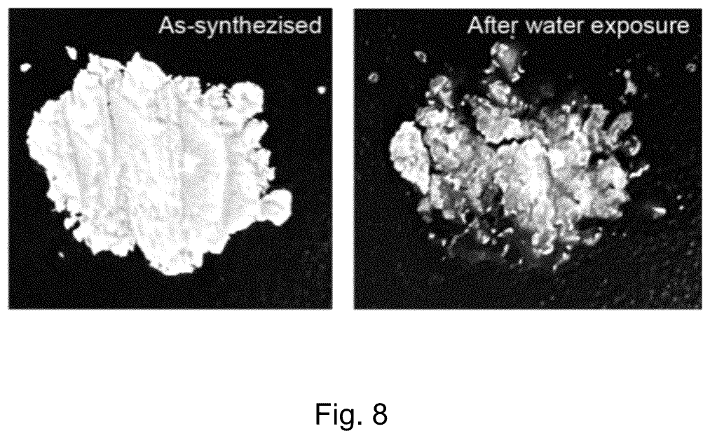

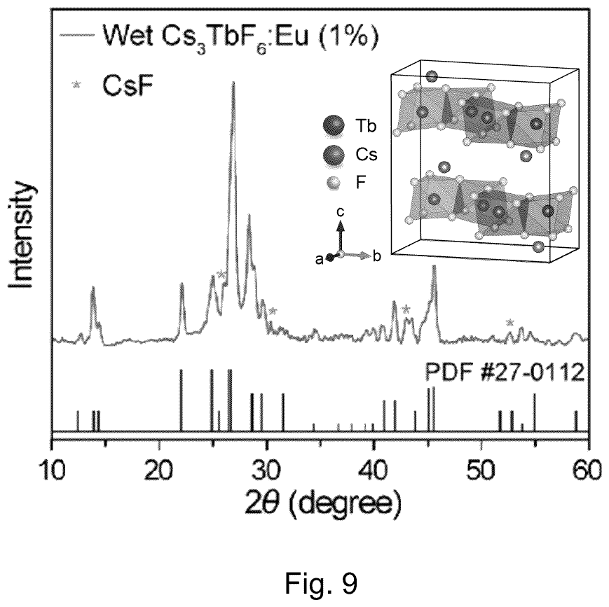

It is noticed that the as-prepared Cs₃TbF₆:Eu³⁺ crystals were hygroscopic and changed their appearance upon exposure to a humid environment (FIG. 8). XRD characterization of the wet sample revealed a phase transformation into orthorhombic CsTb₂F₇(FIG. 9). The XRD pattern also shows impurity peaks of CsF, as marked with asterisks. Thus, the phase transformation can be ascribed to a CsF-stripping process:

$$2 {Cs}_{3} {TbF}_{6} {\to }^{water} {CsTb}_{2} {F}_{7} + 5 CsF$$

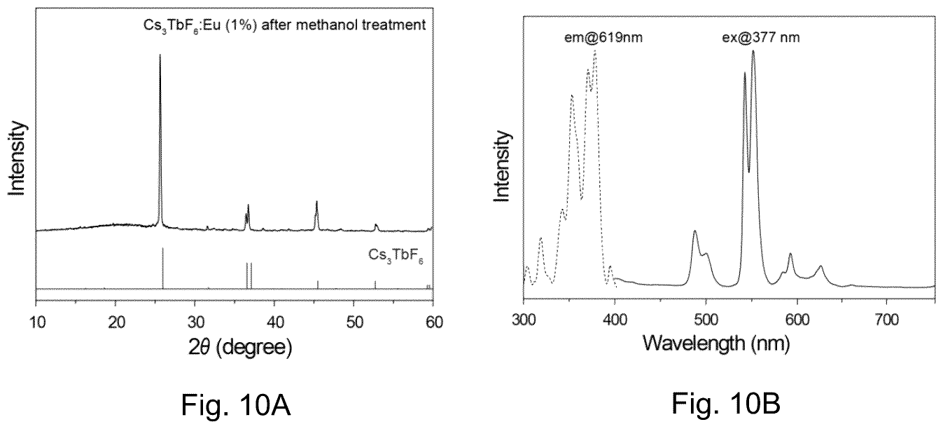

The stripping reaction was primarily due to the high solubility of CsF in water, as the sample remained stable in methanol that is a poor solvent for CsF (FIGS. 10A and 10B).

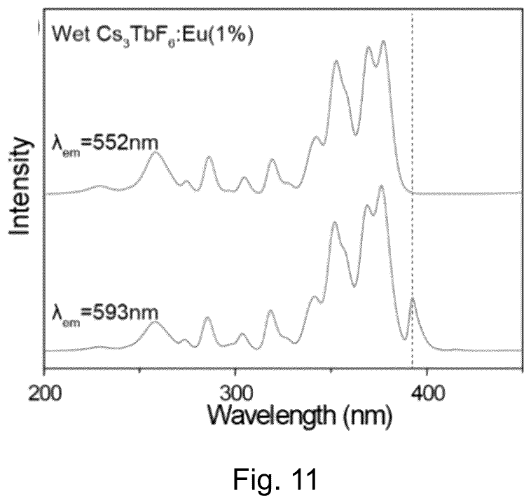

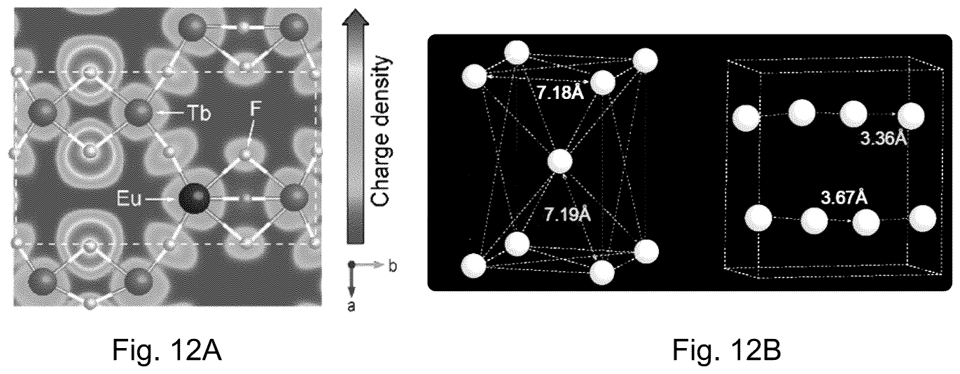

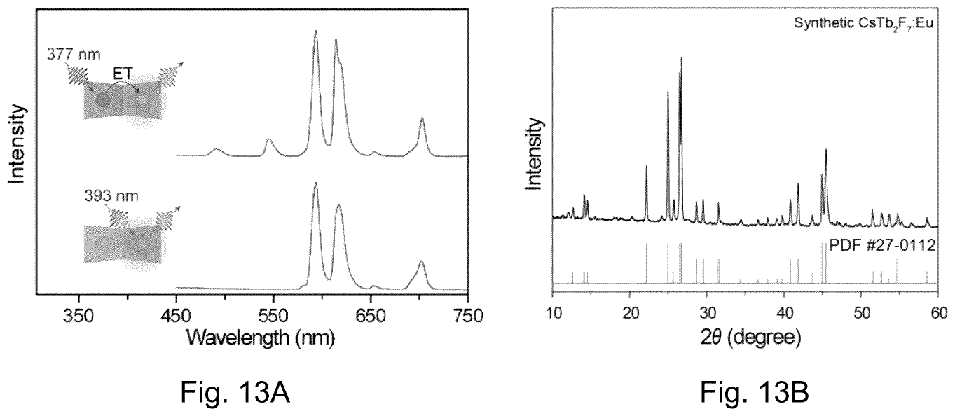

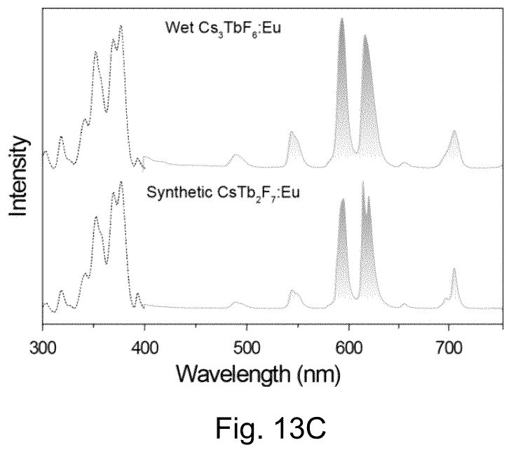

The f-f transitions of Tb³⁺ and Eu³⁺ ions in the CsTb₂F₇:Eu³⁺ crystals were essentially the same as those in the parent Cs₃TbF₆:Eu³⁺ (FIG. 11). However, the orthorhombic phase with a one-dimensional (1D) lattice structure activated the coupling of neighboring polyhedral units due to the contraction of the lanthanide sublattice (FIGS. 12A and 12B), leading to luminescence processes that are essentially independent of the excitation wavelength. In specific, the emission spectra were dominated by Eu³⁺ peaks under both 377 and 393 nm excitation (FIG. 13A), revealing a unidirectional energy transfer from Tb³⁺ to Eu³⁺. On a separate note, the hydrolyzed sample closely resembled the spectra of directly synthesized CsTb₂F₇:Eu³⁺ (1%) (FIG. 13B), suggesting the absence of lanthanide segregation during the phase transformation.

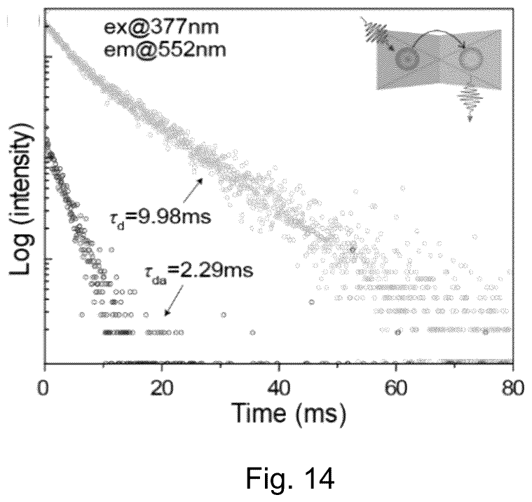

Time decay studies detected an appreciable shortening of Tb³⁺ lifetime from 9.98 to 2.29 ms in the wet Cs₃TbF₆ (or CsTb₂F₇) crystals due to 1% of Eu³⁺ doping (FIG. 14). Correspondingly, the experimental energy transfer efficiencies were calculated based on the measured lifetimes using the following equation:

$${η}_{ET} = 1 - \frac{{τ}_{da}}{{τ}_{d}}$$

where τ_{da} and τₐ are the ⁵D₄ lifetimes of Tb³⁺ in undoped and Eu³⁺-doped samples, respectively. The results confirmed a high Tb³⁺-to-Eu³⁺ energy transfer efficiency of 77.1% in the CsTb₂F₇:Eu³⁺ (1%) crystals.

### Example 3

### Hydrochromic Properties

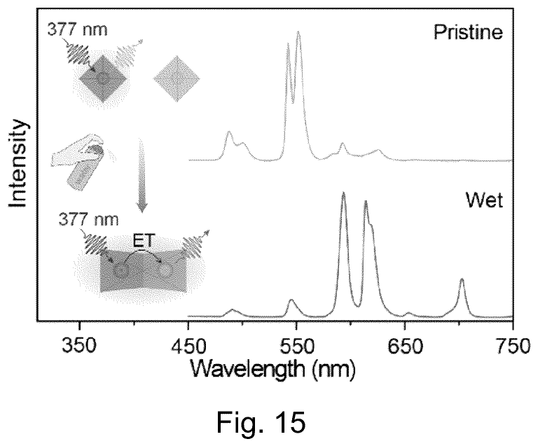

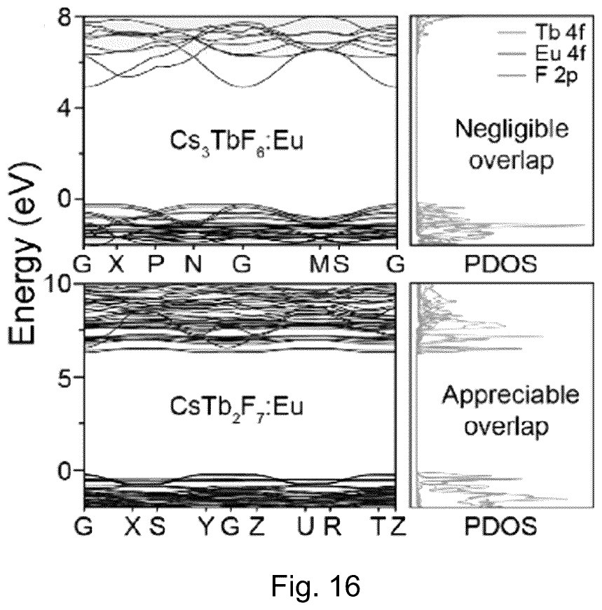

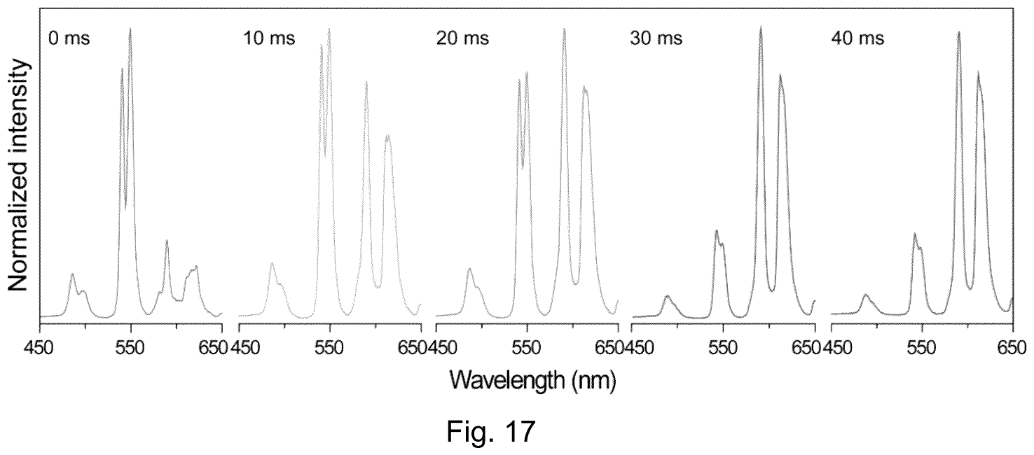

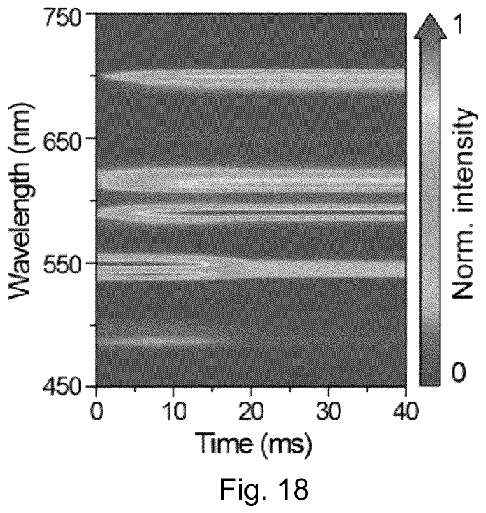

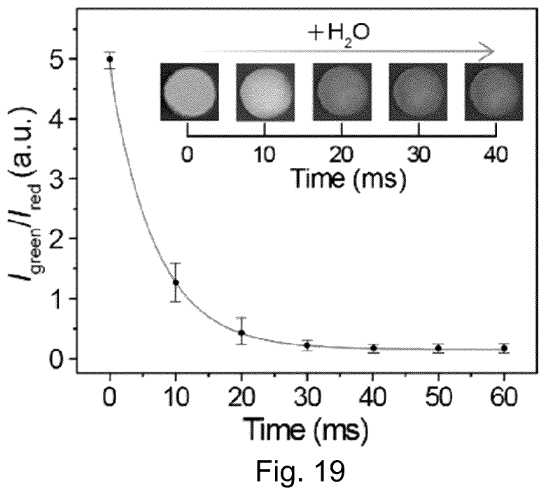

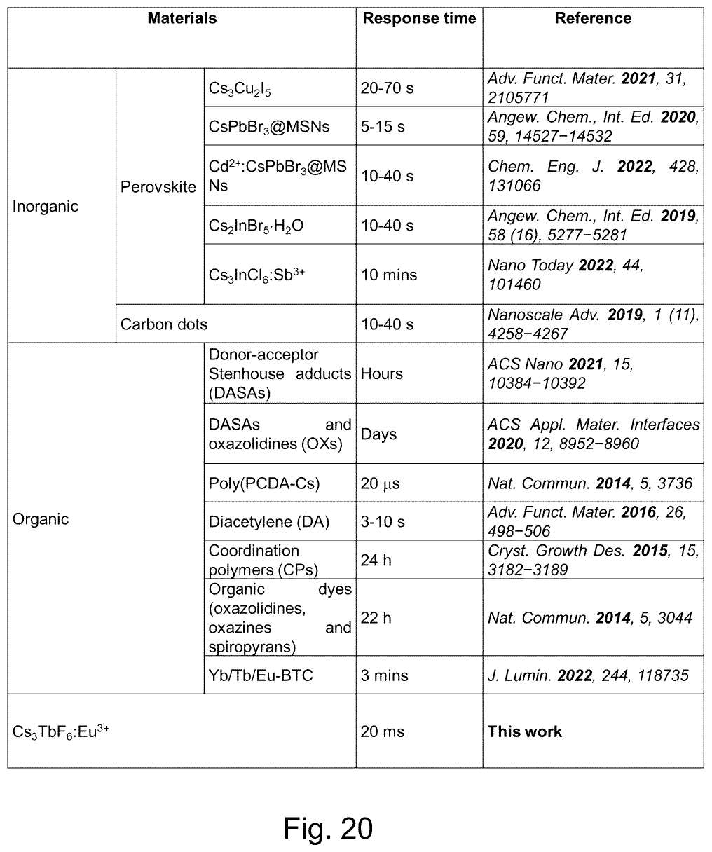

Due to the water-induced phase transformation, the Cs₃TbF₆:Eu³⁺ crystals displayed a hydrochromic luminescence switching under constant 377 nm excitation (FIG. 15). The sharp emission color shift from green to orange suggests a substantial change in energy coupling between the lanthanide centers, which is consistent with our theoretical calculations. As depicted in FIG. 16, the phase transition resulted in an appreciable overlap of the f orbitals of Eu³⁺ and Tb³⁺, which could lead to strong exchange interactions between the ions. Accordingly, the phase transformation process was monitored by inspecting the spectrum change as a function of water contact time (FIG. 17). As shown in FIG. 18, the emission intensity balance of Tb³⁺ and Eu³⁺, which were correlated with the relative amount of Cs₃TbF₆:Eu³⁺ and CsTb₂F₇:Eu³⁺ in the sample, rapidly dropped upon water contact. By plotting the green-to-red emission intensity ratio of Tb³⁺ and Eu³⁺ against time (FIG. 19), the hydrochromic response time was determined to be 20 ms, corresponding to 90% completion of the color switching. In particular, it is believed that such a rapid hydrochromic response has not been observed in any of the reported inorganic hydrochromic materials and in most of the reported organic hydrochromic materials (FIG. 20).

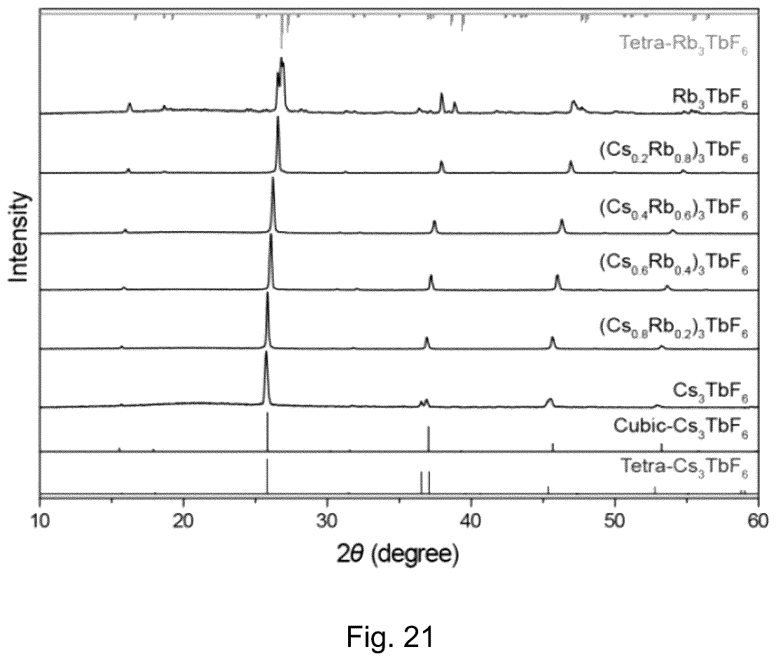

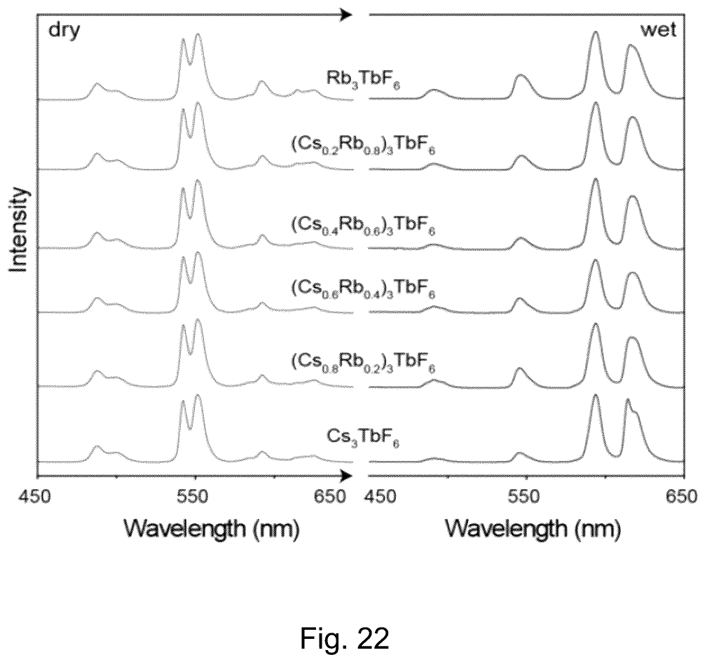

It is believed that the ultrafast phase transformation as observed herein is largely benefited from the extra high solubility of CsF in water (3690 g/L at 18° C.), which elicits the absorption of water layers around the crystals. To support this hypothesis, a series of Rb-alloyed Cs₃TbF₆:Eu³⁺ (i.e., Cs₃₋ₓRbₓTbF₆:Eu³⁺ (1%), with x being 0.6, 1.2, 1.8, 2.4, or 3) has been synthesized and characterized by XRD. As shown in FIG. 21, the XRD pattern of Cs₃₋ₓRbₓTbF₆:Eu³⁺ (1%) shifts gradually toward higher diffraction angles, which may be attributed to the substitution of apparently smaller Rb⁺ for Cs⁺ centers in the crystal lattice, resulting in a smaller unit-cell volume. Upon excitation at about 377 nm, each of the pristine (dry) Cs₃₋ₓRbₓTbF₆:Eu³⁺ and wet Cs₃₋ₓRbₓTbF₆:Eu³⁺ shows an emission spectrum that is substantially resemble to those of pristine (dry) Cs₃TbF₆:Eu³⁺ and wet Cs₃TbF₆:Eu³⁺, respectively (FIG. 22).

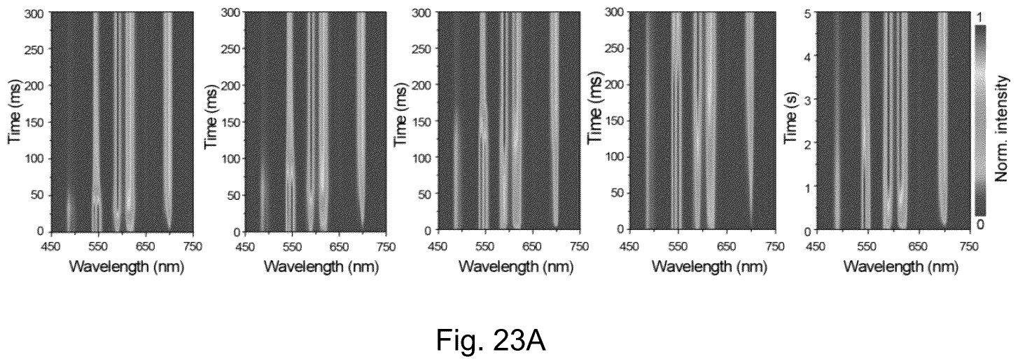

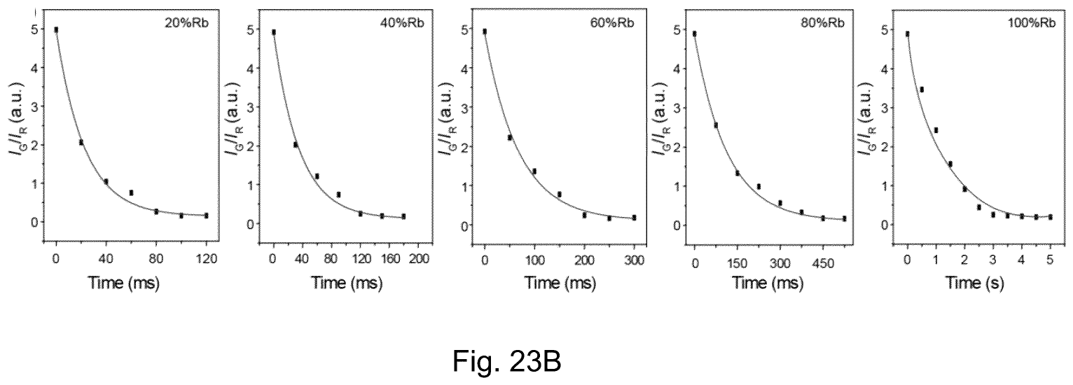

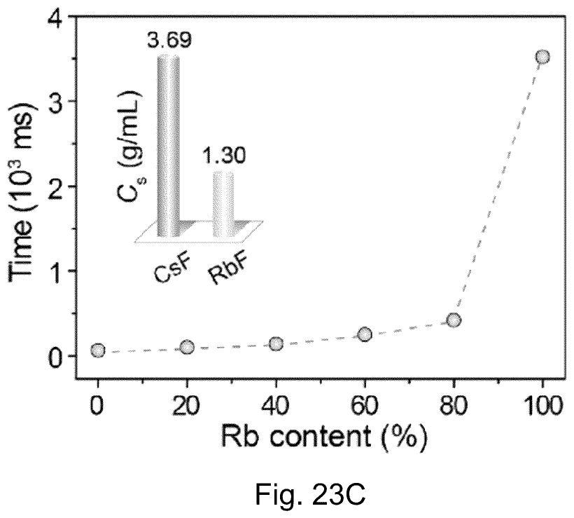

FIGS. 23A to 23C illustrate the hydrochromic emissions of Rb-alloyed Cs₃TbF₆:Eu³⁺ as a function of water exposure time and the hydrochromic response time of Rb-alloyed Cs₃TbF₆:Eu³⁺ as a function of Rb⁺ doping concentration. As shown, it is observed that the hydrochromic response time in Rb-alloyed Cs₃TbF₆:Eu³⁺ is increased, and, in particular, a substantially slow phase transformation was detected for Cs-free Rb₃TbF₆:Eu³⁺, suggesting the production of less water-soluble RbF (1306 g/L at 18° C.); or in other words, markedly reduced water absorption in the absence of CsF.

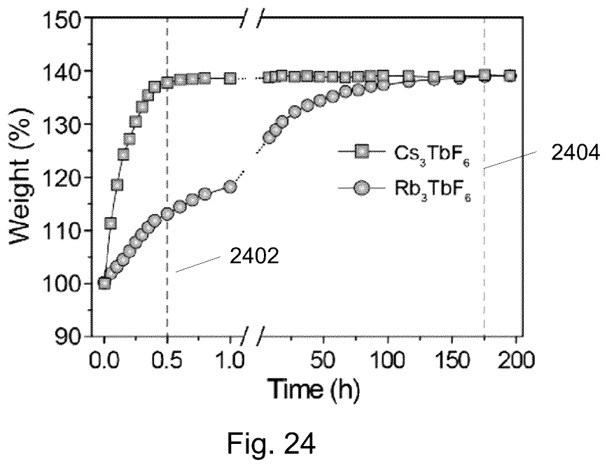

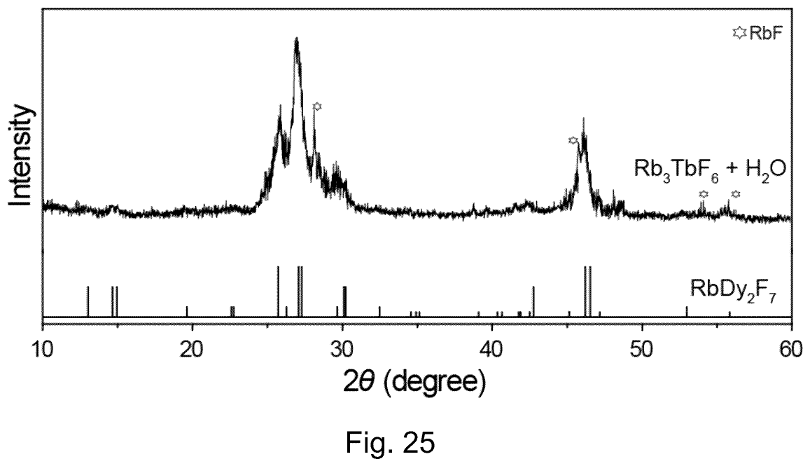

The higher hygroscopicity of Cs₃TbF₆:Eu³⁺ than Rb₃TbF₆:Eu³⁺ was further demonstrated by examining the weight evolution of the crystals in the ambient environment (25° C., 45 RH %). As summarized in FIG. 24, Cs₃TbF₆:Eu³⁺ reached weight saturation much faster (˜30 min) than Rb₃TbF₆:Eu³⁺ (˜175 h), which agreed with the promotion of water absorption by CsF. Notably, the relative weight increases for Cs₃TbF₆:Eu³⁺ and Rb₃TbF₆:Eu³⁺ at the end of moisture exposure were essentially the same, suggesting that the two crystals experienced similar interactions with water, as confirmed by XRD characterizations (FIG. 25).

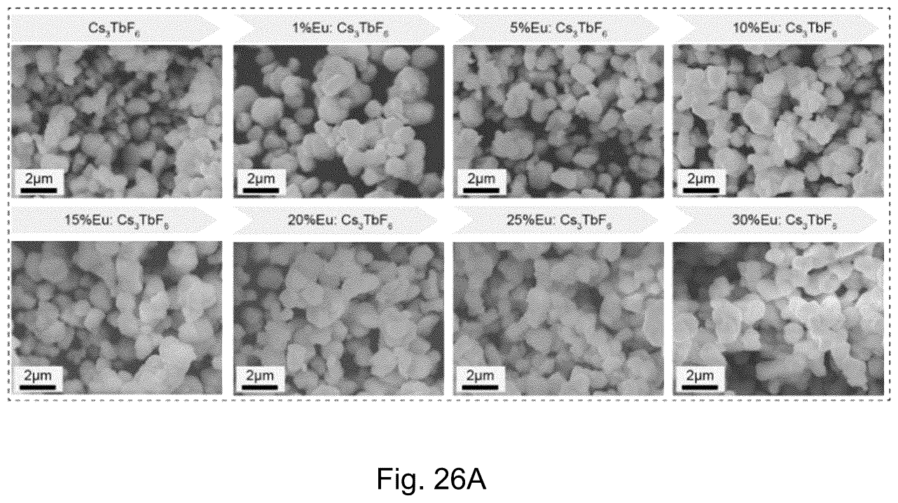

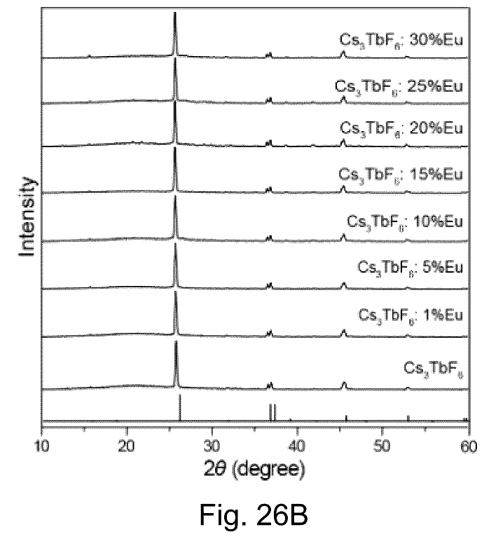

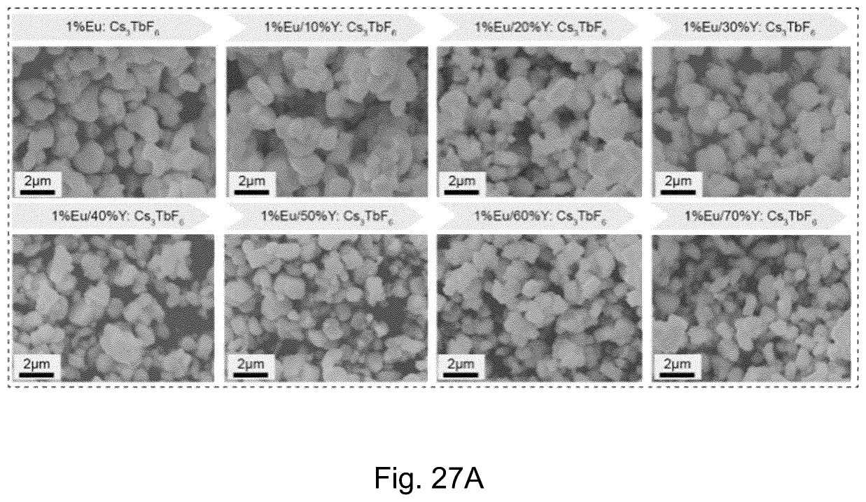

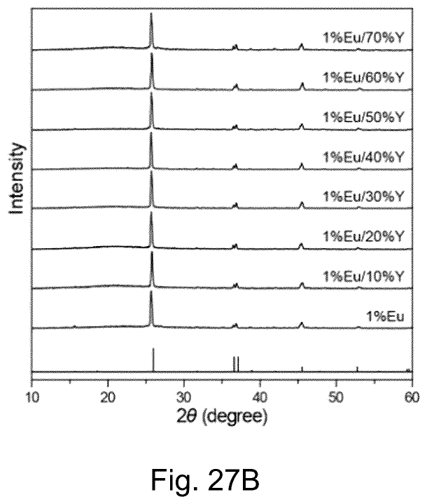

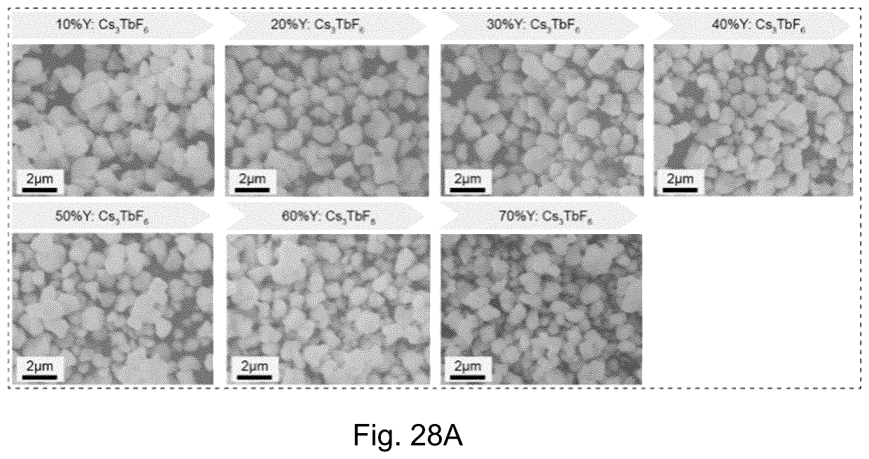

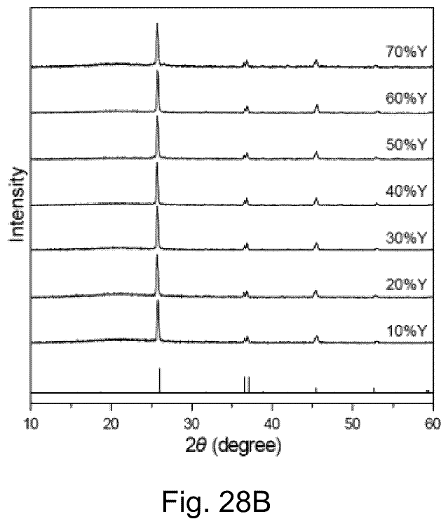

Conventional hydrochromic crystals such as CsPbBr₃ typically display optical features associated with the band gap of the host lattice, leading to pre-fixed hydrochromic properties specific to the crystals. By contrast, the luminescence switching in the present invention of lanthanide-doped Cs₃TbF₆ is controlled by interaction of individual polyhedrons. Therefore, the hydrochromic behavior can be easily tuned by engineering the inter-polyhedral energy transfer through supplementary doping, such as by way of increasing the doped lanthanide ion concentration, co-doping another lanthanide ion and/or rare earth metal ion, etc. As a support, series of Cs₃TbF₆:Eu³⁺ (1% to 30%), Cs₃TbF₆:Eu³⁺/Y³⁺ (1% Eu³+/0 to 70% Y³⁺), and Cs₃TbF₆:Y³⁺ (10% to 70%) are synthesized and characterized. In general, the crystal phase and morphology were largely preserved after doping of Eu³⁺ and/or rare-earth ions at high concentrations (FIGS. 26A and 26B, 27A and 27B, 28A and 28B). On particular note, the spectral shift of the XRD patterns of Cs₃TbF₆:Eu³⁺ (0% to 30%) toward lower diffraction angles can be attributed to the substitution of apparently larger Eu³⁺ for Tb³⁺ centers in the crystal lattice, resulting in a larger unit-cell volume.

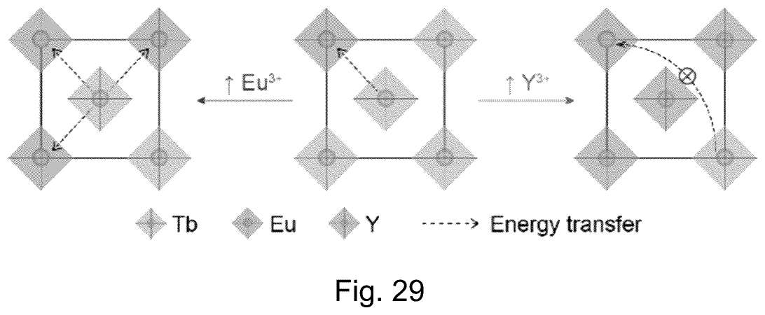

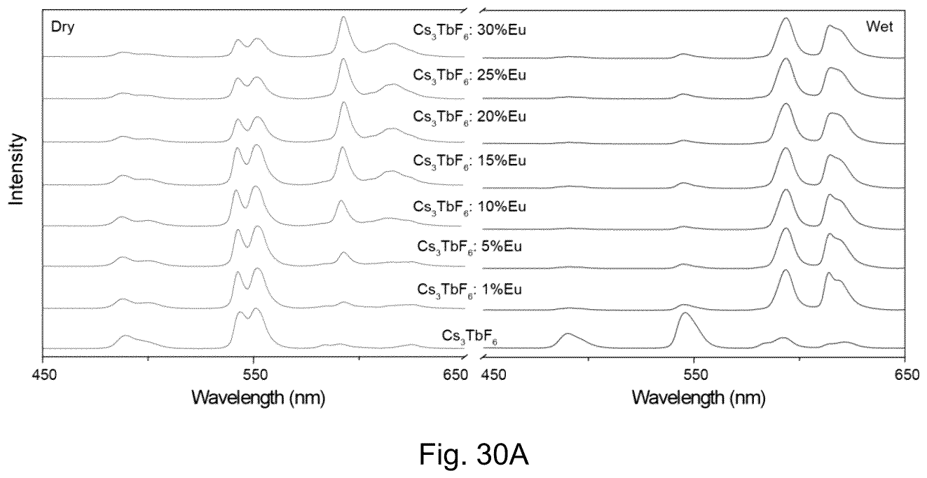

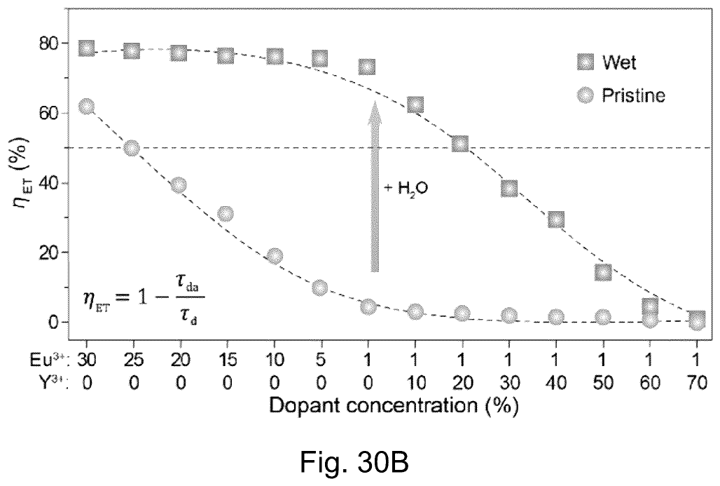

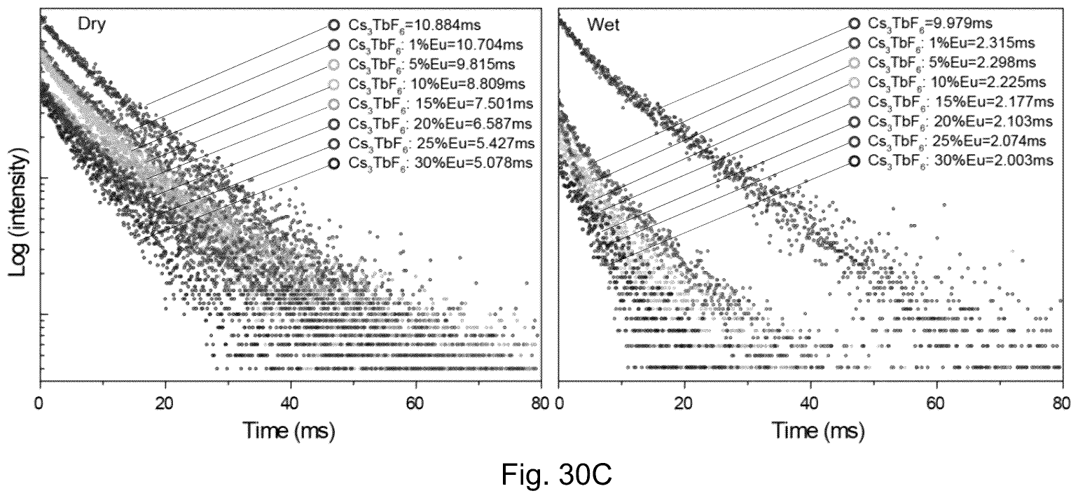

By increasing the Eu³⁺ doping concentration, the Tb³⁺-to-Eu³⁺ energy transfer was strengthened (FIG. 29) due to the promotion of acceptor absorption based on the Förster theory:

$${k}_{ET} ∝ \frac{{κ}^{2}}{{r}^{2}} {\int }_{0}^{∞} {F}_{D} ( λ ) {ε}_{A} ( λ ) {λ}^{4} d λ$$

where κ² is an orientation factor, r is the donor-acceptor distance, and F_{D}(λ)/ε_{A}(λ) is the donor emission/acceptor absorption strength at wavelength λ. Accordingly, largely enhanced Eu³⁺ emissions in pristine Cs₃TbF₆:Eu³⁺ crystals at high doping levels (e.g., 30%) was observed (FIG. 30A). Subsequent phase transformation by water exposure only induced minor changes in the emission profile due to a minor increase in energy transfer efficiency (FIGS. 30B and 30C).

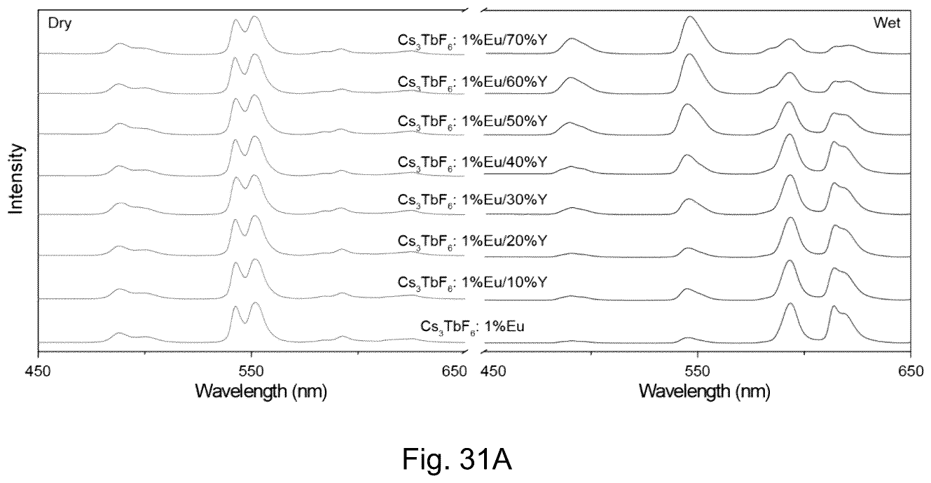

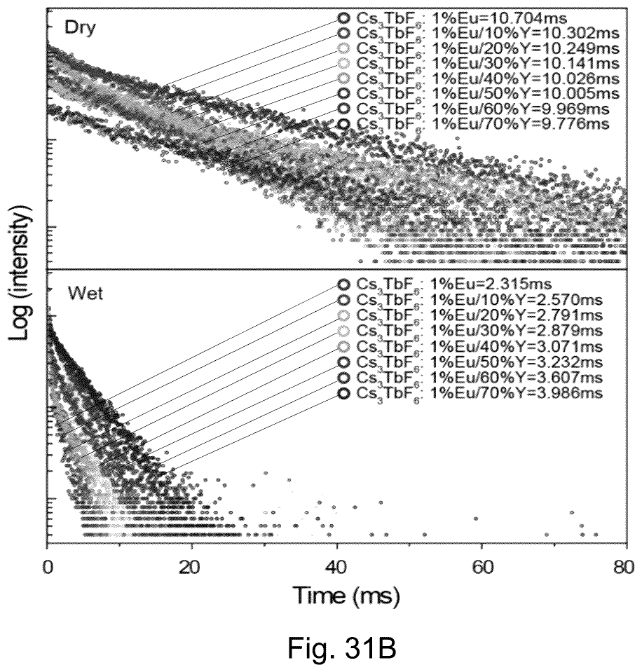

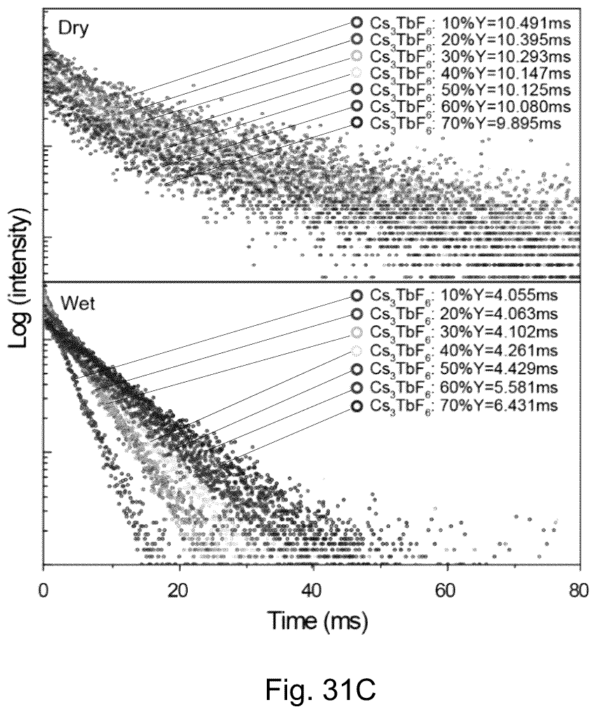

In addition, the energy transfer process can be inhibited by incorporating inert Y³⁺ ions into the host lattice, which increases the interionic distance (r) of Tb³⁺ and Eu³⁺ according to Blasse's equation:

$$r = 2 {( \frac{3 V}{4 π cN} )}^{1 / 3}$$

where c is the total concentration of Tb³⁺ and Eu³⁺, N is the number of lanthanide sites in the unit cell, and V is the volume of the unit cell. By increasing the Y³⁺ doping concentration, hydrochromic switching was steadily suppressed because the phase transformation could no longer bring the Tb³⁺ and Eu³⁺ ions into close proximity (FIGS. 29 and 31A to 31C).

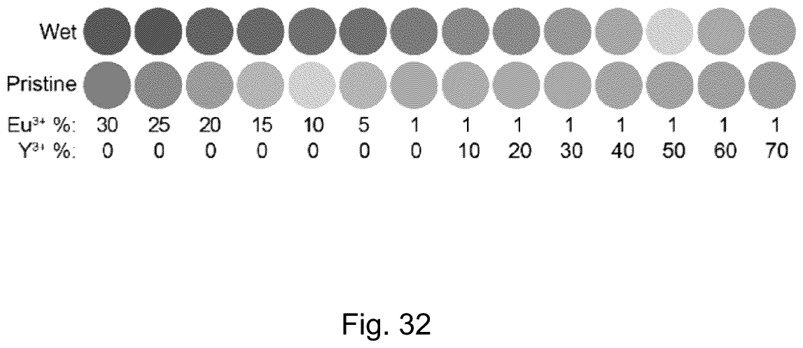

Accordingly, it is appreciated that by the doping-mediated administration of inter-polyhedral energy transfer as discussed above, it would allow fine-tuning of the hydrochromic properties. That said, the emission color before and after water treatment of Cs₃TbF₆:Eu³⁺ could be fine-tuned by doping with different concentrations of Eu³⁺ and/or co-doping with different concentrations of Y³⁺ (FIG. 32). For example, as shown, the emission color of pristine Cs₃TbF₆:Eu³⁺ under 365 nm excitation may change from green to orange by increasing the doped-Eu³⁺ concentration from 1 mol % to 30 mol % while reducing the co-doping concentration of Y³⁺ from 70 mol % to 0 mol %. On the other hand, the emission color of the wet Cs₃TbF₆:Eu³⁺/Y³⁺ may change from orange to green upon reducing the Eu³⁺ concentration (from 30 mol % to 1 mol %) while increasing the co-doped Y³⁺ concentration (from 0 mol % to 70 mol %).

Optionally or additionally, the emission color of the pristine-wet pair of Cs₃TbF₆:Eu³⁺/Y³⁺ may be further fine-tuned by use of different excitation wavelengths. For example, when the excitation wavelength used for exciting Cs₃TbF₆:Eu³⁺/Y³⁺ (1%-30% Eu³+/0% Y³⁺) is changed from 365 nm to 393 nm, the emission color of the pristine Cs₃TbF₆:Eu³⁺/Y³⁺ will change from non-fluorescent to pink (red).

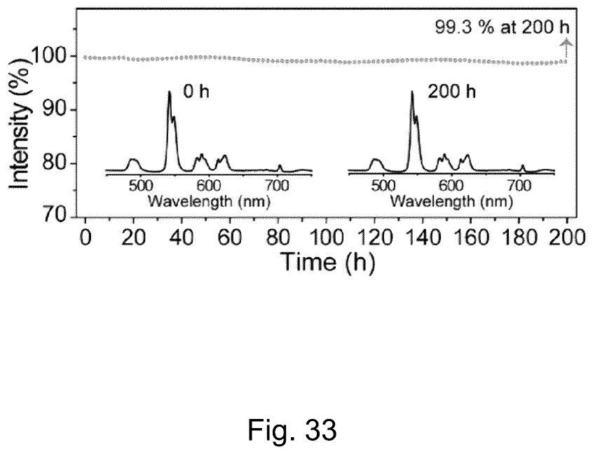

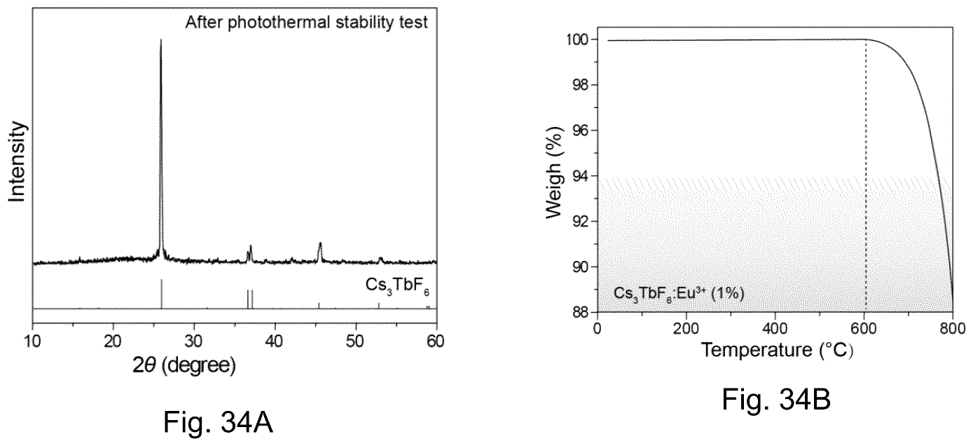

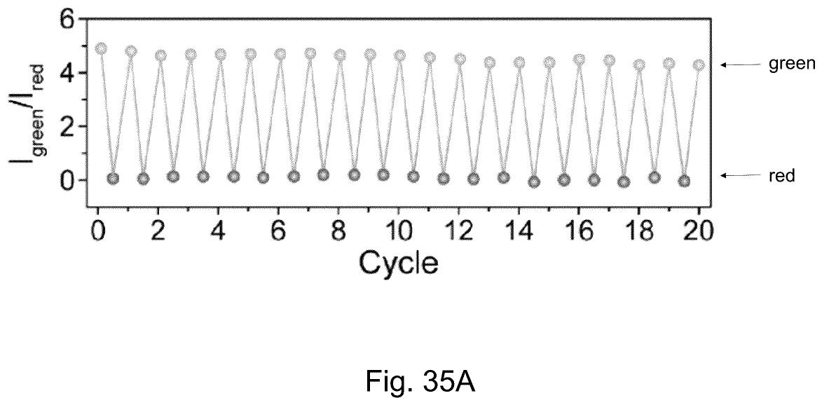

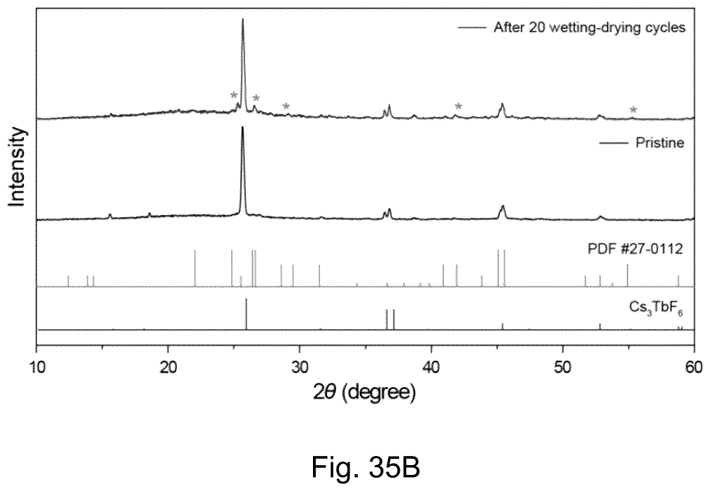

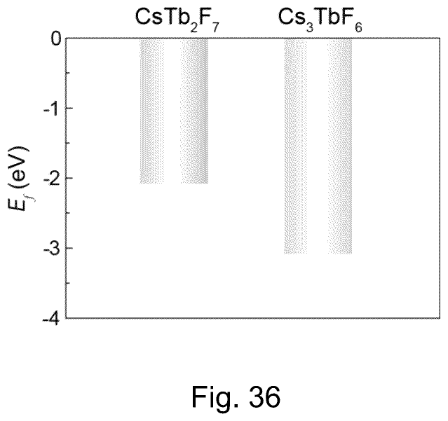

On top of the fast and multicolor hydrochromic switching, the Cs₃TbF₆:Eu³⁺ crystals also feature reversible phase transformation and high photothermal stability. As plotted in FIG. 33, the sample displayed no noticeable changes in integral intensity and emission profile under continuous irradiation of a 365 nm UV lamp at 373 K for 200 h. Additionally, the sample structure was essentially unaffected by the heat treatment, and the sample weight remained steady at temperatures up to ˜600° C. (FIGS. 34A and 34B). Furthermore, the original emission color can be essentially recovered by losing water for 20 wetting-drying cycles (FIG. 35A), owing to retrieval of the initial crystal phase, as confirmed by XRD characterizations (FIG. 35B). The observations were attributed to the higher stability of Cs₃TbF₆ than CsTb₂F₇ in anhydrous environments, resulting from the lower formation energy (−3.11 eV for Cs₃TbF₆ and −2.13 eV for CsTb₂F₇) based on density functional theory (DFT) calculations (FIG. 36).

### Example 4

### Encryption Application

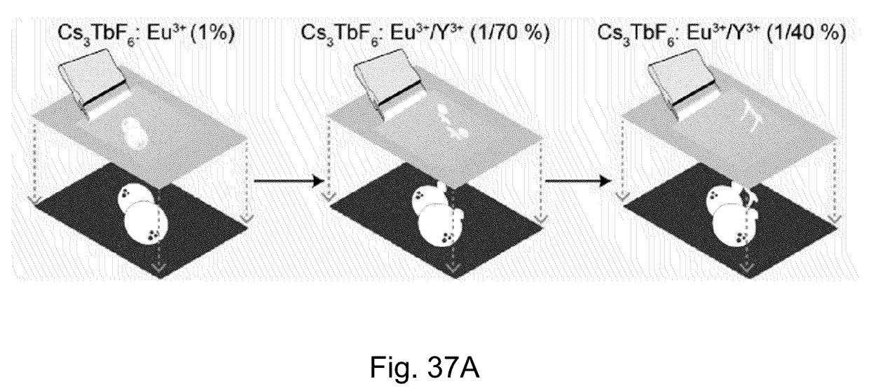

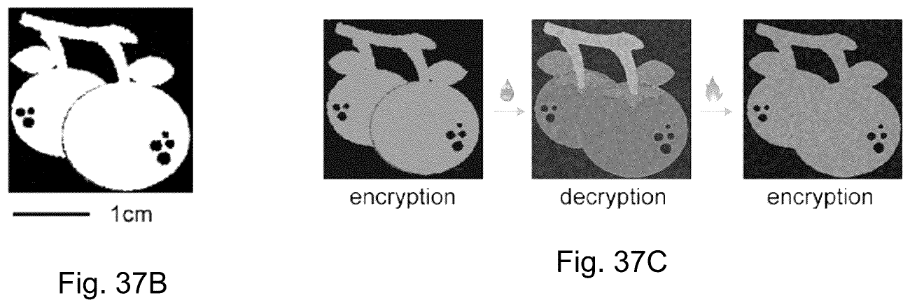

It is believed that the ability of the crystals to deliver tunable emissions in response to external stimulus provides excellent opportunities for information encryption. As a proof of concept, a multicolor graphic was protected by jointly using Cs₃TbF₆:Eu³⁺ (1%), Cs₃TbF₆:Eu³⁺/Y³⁺ (1%/70%), and Cs₃TbF₆:Eu³⁺/Y³⁺ (1%/40%) crystals, which were patterned through serial screen printing on a cardstock substrate (FIG. 37A). As shown in FIGS. 37B and 37C, the security information was only recognizable under simultaneous UV excitation and water stimulus, which could be concealed again by the evaporation of water.

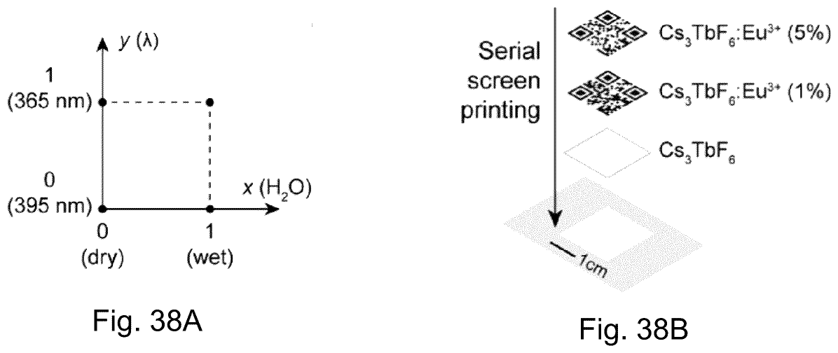

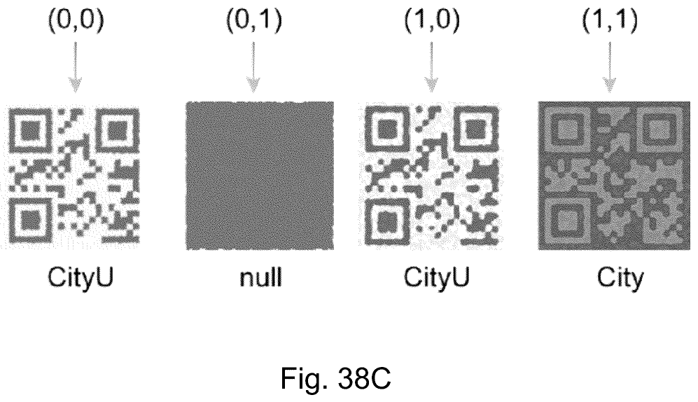

Furthermore, a two-dimensional encryption method was devised by combining the stimulus-responsive and excitation-wavelength-dependent features of the Cs₃TbF₆:Eu³⁺ crystals (FIG. 38A). In an illustrative design, text information “City” was encrypted into a quick response (QR) code and printed using Cs₃TbF₆:Eu³⁺ (1%) against a Cs₃TbF₆ background. A protection QR code of “CityU” was further printed in the same position using Cs₃TbF₆:Eu³⁺ (5%) (FIG. 38B). FIG. 39C shows the output codes under diverse excitation/stimulus parameters. The encrypted information can only be extracted using a particular combination of excitation wavelength and stimulus condition.

As shown, at (0, 0) conditions (i.e., dry state, kₑₓ=395 nm), Cs₃TbF₆ is not excitable upon 395 nm excitation but Cs₃TbF₆:Eu³⁺ (1%) and Cs₃TbF₆:Eu³⁺ (5%) instead. However, it is believed that owing to the low Eu³⁺ content in Cs₃TbF₆:Eu³⁺ (1%), the “City” QR code is too weak to be recognized and therefore only the pink “CityU” QR code as printed by Cs₃TbF₆:Eu³⁺ (5%) would be observable by naked eyes. Upon changing the excitation to 365 nm (i.e., (0, 1) condition), the optical emission is dominated by Tb³⁺ in all the three halide perovskites, resulting in a green emission. Further changing the conditions to (1, 0) (i.e., wet state, λₑₓ=395 nm), substantially the same result was observed as that with (0, 0) conditions, which may be accounted for by the same reason as mentioned above. Finally, at (1, 1) conditions (i.e., wet state, λₑₓ=365 nm), an orange “City” QR code against a green background is recognizable by naked eyes. It is appreciated that the recognizable “City” QR code may be attributed to the incomplete (i.e., lower than 100%) energy transfer efficiency from Tb³⁺ to Eu³⁺ under 365 nm or 377 nm excitation, rendering part of the Tb emission at about 550 nm retained and therefore an apparently a brighter emission, as compared to the (1, 1) case of which the emission is solely dependent on the Eu³⁺ emission.

Given the inherent merits of environmental friendliness and easy production, it is believed that the Cs₃TbF₆ crystals may hold great promise for multilevel data storage and anti-counterfeiting applications.

The invention has been given by way of example only, and various other modifications of and/or alterations to the described embodiment may be made by persons skilled in the art without departing from the scope of the invention as specified in the appended claims.

1. A hydrochromic halide perovskite comprising a CsₓTb_{y}F_{z} halide perovskite doped with a lanthanide ion dopant, which is capable of water-induced reversible phase transformation between pristine state and wet state, and exhibits reversible change in optical emission under ultraviolet excitation.

2. The hydrochromic halide perovskite as claimed in claim 1, wherein the lanthanide ion dopant comprises Eu³⁺, in the pristine state, x is 3, y is 1 and z is 6, and in the wet state, x is 1, y is 2 and z is 7.

3. The hydrochromic halide perovskite as claimed in claim 2, wherein the optical emission of Cs₃TbF₆ doped with Eu³⁺ can be controlled by changing the wavelength of the ultraviolet during the ultraviolet excitation.

4. The hydrochromic halide perovskite as claimed in claim 3, wherein the wavelength is selected from any one of between about 365 nm to about 395 nm.

5. The hydrochromic halide perovskite as claimed in claim 2, wherein the optical emission of Cs₃TbF₆ doped with Eu³⁺ under UV excitation at specific wavelength is changeable by adjusting concentration of the Eu³⁺ dopant.

6. The hydrochromic halide perovskite as claimed in claim 2, wherein the halide perovskite is reversibly transformable between a zero-dimensional structure of Cs₃TbF₆ at the pristine state and a one-dimensional structure of CsTb₂F₇ in the wet state.

7. The hydrochromic halide perovskite as claimed in claim 2, wherein the optical emission of Cs₃TbF₆ doped with Eu³⁺ under the UV excitation at about 365 nm is changeable from green to orange by adjusting concentration of the Eu³⁺ dopant when the Cs₃TbF₆ doped with Eu³⁺ is in the pristine state.

8. The hydrochromic halide perovskite as claimed in claim 2, wherein the optical emission of Cs₃TbF₆ doped with Eu³⁺ under UV excitation at about 393 nm is changeable from non-fluorescent to pink by adjusting concentration of the Eu³⁺ dopant when the Cs₃TbF₆ doped with Eu³⁺ is in the pristine state.

9. The hydrochromic halide perovskite as claimed in claim 1, wherein the CsₓTb_{y}F_{z} is co-doped with the lanthanide ion dopant and a rare earth metal ion, optical emission wavelength of a co-doped lanthanide-based halide perovskite is changeable by adjusting relative concentration of the lanthanide ion dopant and rare earth metal ion dopant.

10. The hydrochromic halide perovskite as claimed in claim 9, wherein x is 1 or 3, y is 1 or 2 and z is 6 or 7 and the lanthanide ion dopant comprises Eu³⁺ and the rare earth metal ion comprises Y³⁺, the optical emission under UV excitation is changeable by adjusting concentration of the Eu³⁺ and Y³⁺ dopants.

11. The hydrochromic halide perovskite as claimed in claim 10, wherein the concentration of the Eu³⁺ dopant is adjustable between 1 mol % and 30 mol % and the concentration of the Y³⁺ dopant is adjustable between 0 mol % and 70 mol %.

12. The hydrochromic halide perovskite as claimed in claim 11, wherein the optical emission of CsTb₂F₇ doped with Eu³⁺ and Y³⁺ ions under UV excitation at about 365 nm is changeable from orange to green by adjusting concentration of the Eu³⁺ and Y³⁺ dopants.

13. The hydrochromic halide perovskite as claimed in claim 6, wherein the transformation from the zero-dimensional structure to the one-dimensional structure reaches 90% in a response time of about 20 ms.

14. The hydrochromic halide perovskite as claimed in claim 13, wherein the response time is changeable by adjusting water absorption ability of the Eu³⁺ doped CsₓTb_{y}F_{z}.

15. The hydrochromic halide perovskite as claimed in claim 14, wherein the water absorption ability of the Eu³⁺ doped CsₓTb_{y}F_{z} is adjustable by partly forming Rb-alloyed Cs₃TbF₆:Eu³⁺.

16. A printable pattern comprising a film of hydrochromic halide perovskite as claimed in claim 1.

17. The printable pattern as claimed in claim 16, wherein the film comprises at least first and second layers, the first layer comprises CsₓTb_{y}F_{z} doped with Eu³⁺ ion.

18. The printable pattern as claimed in claim 17, wherein the second layer comprises CsₓTb_{y}F_{z} doped with Eu³⁺ and Y³⁺ ions or Cs₃TbF₆.

19. A method for preparing the hydrochromic halide perovskite as claimed in claim 1, comprising the steps of:
providing a mixture comprising a Cs source, a Tb source, a F source, and a lanthanide source; and
annealing the mixture at an elevated temperature for a predetermined time.

20. The method as claimed in claim 19, further comprising a step of grinding the mixture prior to annealing.

21. The method as claimed in claim 19, wherein the mixture comprises stoichiometric amount of CsCO₃, TbF₃, NH₄F, and EuF₃.

22. The method as claimed in claim 21, wherein molar ratio of Cs:Tb:F:Eu in the mixture is from about 3:0.99:6:0.01 to about 3:0.7:6:0.3.

23. The method as claimed in claim 21, wherein the mixture further comprises YF₃.

24. The method as claimed in claim 23, wherein molar ratio of Cs:Tb:F:Eu:Y in the mixture is from about 3:0.99:6:0.01:0.1 to about 3:0.29:6:0.01:0.7.

25. The method as claimed in claim 21, wherein the mixture further comprises Rb₂CO₃.

26. The method as claimed in claim 25, wherein molar ratio of Cs:Rb:Tb:F:Eu in the mixture is from about 2.4:0.6:0.99:6:0.01:0.1 to about 0:3:0.99:6:0.01:0.1.

27. The method as claimed in claim 19, wherein the annealing is performed at about 150° C. to about 500° C. for about 2 h.
